(19) United States
(12) Patent Application Publication
(10) Pub. No.: US 2026/0250170 A1
(43) Pub. Date: Aug. 27, 2026

(54) METHODS AND SYSTEMS FOR TREATING AQUEOUS EFFLUENT

(71) Applicant: Gradiant Corporation, Woburn, MA (US)

(72) Inventors: Siva Kumar Kota, Abu Dhabi (AE); Hiep Thanh Huynh Le, Singapore (SG)

(73) Assignee: Gradiant Corporation, Woburn, MA (US)

(21) Appl. No.: 18/998,665

(22) PCT Filed: Jul. 28, 2023
(86) PCT No.: PCT/US2023/028930

§ 371 Date: Jan. 27, 2025

Related U.S. Application Data
(60) Provisional application No. 63/393,127, filed on Jul. 28, 2022.

(51) Int. Cl. C02F 9/00; C02F 1/00; C02F 1/22; C02F 1/44; C02F 101/34

(52) U.S. Cl. CPC C02F 9/00; C02F 1/004; C02F 1/22; C02F 1/441; C02F 1/442; C02F 1/444; C02F 2101/34; C02F 2201/006; C02F 2209/02; C02F 2209/08; C02F 2209/20; C02F 2301/08

(57) ABSTRACT

Systems and methods for treating an aqueous effluent, and more specifically, to systems and methods for treating an aqueous effluent containing isopropyl alcohol. The system includes an inlet configured to receive an aqueous effluent. The system further includes a filtration assembly to filter the impurities from the aqueous effluent. The system also includes a cooling assembly to reduce the temperature of the filtered aqueous effluent.

### RELATED APPLICATIONS

This application claims priority under 35 U.S.C. § 119(e) to U.S. Provisional Patent Application No. 63/393,127, filed Jul. 28, 2022, and entitled “Methods and Systems for Treating Aqueous Effluent,” which is incorporated herein by reference in its entirety for all purposes.

### TECHNICAL FIELD

The present disclosure relates generally to systems and methods for treating an aqueous effluent, and more specifically, to systems and methods for treating an aqueous effluent containing isopropyl alcohol.

### BACKGROUND

Isopropyl alcohol (IPA) is widely used in various industries, including semiconductor manufacturing, optoelectronic manufacturing and others. It is a significant organic pollutant, with other common organic reagents are present at high concentrations in the wastewater, and are difficult to treat due to its organic toxicity and high chemical oxygen demand. Isopropyl alcohol and the other organic pollutants are volatile in nature and if not treated or decomposed efficiently, will have detrimental effect on the quality of the water and/or wastewater in the environment. Furthermore, isopropyl alcohol and other organic pollutants, if not properly treated or decomposed, may also result in a failure to meet water and/or wastewater discharge standards, regulations, and/or policies in place from time to time in one or more jurisdictions.

### BRIEF SUMMARY

Present example embodiments relate generally to and/or include, among other things, systems, subsystems, processors, devices, logic, methods, and processes for addressing conventional problems, including those described above and in the present disclosure, and more specifically, example embodiments relate to systems, subsystems, processors, devices, logic, methods, and processes for treating an aqueous effluent, including but not limited to, removal of contaminants from liquids. In example embodiments, such contaminant removal and/or recovery includes the removal and recovering of isopropyl alcohol from liquids (e.g., wastewater, or the like).

In an exemplary embodiment, a system for managing an aqueous effluent is described. The system includes an inlet configured to receive an aqueous effluent. The system also includes a filtration assembly. The filtration assembly includes a filtration assembly input configured to receive the aqueous effluent from the inlet. The filtration assembly also includes a filter unit configured to filter impurities from the aqueous effluent to arrive at a filtered aqueous effluent. The filtration assembly also includes a filtration assembly output configured to provide the filtered aqueous effluent to a first cooling assembly. The system also includes a first cooling assembly. The first cooling assembly includes a first cooling assembly input configured to receive the filtered aqueous effluent from the filtration assembly. The first cooling assembly also includes a first cooling unit configured to reduce a temperature from the received filtered aqueous effluent to arrive at a first cooled aqueous effluent. The first cooling assembly also includes a first cooling assembly output configured to provide the first cooled aqueous effluent to an analysis assembly and/or to a freeze concentrator assembly. The system further includes a first analysis assembly. The first analysis assembly includes a first analysis assembly input configured to receive a first analysis influent stream selected from the aqueous effluent, the filtered aqueous effluent and/or the first cooled aqueous effluent. The first analysis assembly also includes a first chemical oxygen demand (COD) analyzer configured to determine a concentration of chemical oxygen demand (COD) in the first analysis influent stream received by the first analysis assembly input and/or a first total organic carbon (TOC) analyzer configured to determine a concentration of organic carbon in the first analysis influent stream received by the first analysis assembly input. The first analysis assembly also includes a first operation temperature processor configured to determine an operation temperature for a first freeze concentrator assembly. The operation temperature may be determined based on the concentration of chemical oxygen demand (COD) determined by the first chemical oxygen demand (COD) analyzer and/or the concentration of total organic carbon (TOC) determined by the first total organic carbon (TOC) analyzer. The first analysis assembly also includes a first analysis assembly output configured to provide the operation temperature determined by the first operation temperature processor. The first freeze concentrator assembly includes a first freeze concentrator assembly input configured to receive the first cooled aqueous effluent. The first freeze concentrator assembly also includes a first freeze concentrator configured to convert the first cooled aqueous effluent received by the first freeze concentrator assembly input to a first solution of first ice slurry and first concentrated isopropyl alcohol. The first freeze concentrator assembly also includes a first freeze concentrator assembly output configured to provide the first solution of first ice slurry and first concentrated isopropyl alcohol to a first separating assembly. The first separating assembly includes a first separating assembly input configured to receive the first solution of first ice slurry and first concentrated isopropyl alcohol from the first freeze concentrator assembly output. The first separating assembly also includes a first separating unit configured to separate the first ice slurry from the first concentrated isopropyl alcohol. The first separating assembly also includes a first separating assembly output configured to provide at least a portion of the first ice slurry to a first warming assembly. The first warming assembly includes a first warming assembly input configured to receive the ice slurry from the first separating assembly output. The first warming assembly also includes a warming unit configured to convert the ice slurry to a first liquid output. The first warming assembly also includes a first warming assembly output configured to provide the first liquid output to a first polishing assembly. The first polishing assembly includes a first polishing assembly input configured to receive the first liquid output from the first warming assembly output. The first polishing assembly also includes a first polishing unit configured to remove impurities from the first liquid output to arrive at a final output. The first polishing assembly also includes a first polishing assembly output configured to provide the final output.

In an exemplary embodiment, a method for managing an aqueous effluent is described. The method includes receiving an aqueous effluent. The method also includes filtering impurities and/or chemical treatment for the removal of impurities from the aqueous effluent to arrive at a filtered aqueous effluent. The impurities may include, but not limited to, particulate matter, sediments, solids, any suspended matters, etc. Other impurities may include oxidizing agents such as hydrogen peroxide (H₂O₂) which may be removed using sodium metabisulfite (SMBS), sodium bisulfite (SBS), sodium hypochlorite (NaOCl) and enzymes. The method further includes reducing a temperature from the received filtered aqueous effluent to arrive at a first cooled aqueous effluent. The method also includes determining a concentration of chemical oxygen demand (COD) in a first analysis influent stream by a chemical oxygen demand (COD) analyzer and/or determining a concentration of total organic carbon (TOC) in the first analysis influent stream by a total organic carbon (TOC) analyzer, the first analysis influent stream being selected from the aqueous effluent, the first filtered aqueous effluent and/or the first cooled aqueous effluent. The method also includes determining an operation temperature by an operation temperature processor for use by a first freeze concentrator assembly. The operation temperature is determined based on the concentration of chemical oxygen demand (COD) and/or the concentration of total organic carbon (TOC) that was determined in the first analysis influent stream. Once the operation temperature is determined, the method includes providing the operation temperature and the first cooled aqueous effluent to the first freeze concentrator assembly. The method further includes converting the first cooled aqueous effluent received by the first freeze concentrator assembly to a first solution of first ice slurry and first concentrated isopropyl alcohol. The method includes separating the ice slurry from the concentrated isopropyl alcohol solution, converting the ice slurry to a first liquid output. The method also includes removing impurities from the first liquid output to arrive at a first final output. The first liquid output are water products which will be further processed by removing remaining impurities, including suspended solids, particles, organics and dissolved solids, to meet the reusable water quality and/or to produce clean or pure water products that has no and/or significantly reduced concentration of isopropyl alcohol.

In an exemplary embodiment, a system for managing an aqueous effluent is described. The system includes an inlet configured to receive an aqueous effluent. The system also includes a filtration assembly. The filtration assembly includes a filtration assembly input configured to receive the aqueous effluent from the inlet. The filtration assembly also includes a filter unit configured to filter impurities from the aqueous effluent and/or a chemical treatment unit configured to remove impurities with the addition of chemicals to arrive at a filtered aqueous effluent. The filtration assembly also includes a filtration assembly output configured to provide the filtered aqueous effluent to a first cooling assembly. The system also includes a first cooling assembly. The first cooling assembly includes a first cooling assembly input configured to receive the filtered aqueous effluent from the filtration assembly. The first cooling assembly also includes a first cooling unit configured to reduce a temperature from the received filtered aqueous effluent to arrive at a first cooled aqueous effluent. The first cooling assembly also includes a first cooling assembly output configured to provide the first cooled aqueous effluent to an analysis assembly and/or to a freeze concentrator assembly. The system further includes a first analysis assembly. The first analysis assembly includes a first analysis assembly input configured to receive a first analysis influent stream selected from the aqueous effluent, the filtered aqueous effluent and/or the first cooled aqueous effluent. The first analysis assembly also includes a first chemical oxygen demand (COD) analyzer configured to determine a concentration of chemical oxygen demand (COD) in the first analysis influent stream received by the first analysis assembly input and/or a first total organic carbon (TOC) analyzer configured to determine a concentration of total organic carbon (TOC) in the first analysis influent stream received by the first analysis assembly input. The first analysis assembly also includes a first operation temperature processor configured to determine an operation temperature for a first freeze concentrator assembly. The operation temperature may be determined based on the concentration of chemical oxygen demand (COD) determined by the first chemical oxygen demand (COD) analyzer and the concentration of total organic carbon (TOC) determined by the first total organic carbon (TOC) analyzer. The first analysis assembly also includes a first analysis assembly output configured to provide the operation temperature determined by the first operation temperature processor. The system also includes a first freeze concentrator. The first freeze concentrator assembly includes a first freeze concentrator assembly input configured to receive the first cooled aqueous effluent from the first analysis assembly output. The first freeze concentrator assembly also includes a first freeze concentrator configured to convert the first cooled aqueous effluent received by the first freeze concentrator assembly input to a first solution of first ice slurry and first concentrated isopropyl alcohol. The first freeze concentrator assembly also includes a first freeze concentrator assembly output configured to provide the first solution of first ice slurry and first concentrated isopropyl alcohol to a first separating assembly. The system also includes a first separating assembly. The first separating assembly includes a first separating assembly input configured to receive the first solution of first ice slurry and first concentrated isopropyl alcohol from the first freeze concentrator assembly output. The first separating assembly also includes a first separating unit configured to separate the first ice slurry from the first concentrated isopropyl alcohol. The first separating assembly also includes a first separating assembly output configured to provide at least a portion of the first ice slurry to a first warming assembly. The system also includes a first warming assembly. The first warming assembly includes a first warming assembly input configured to receive the ice slurry from the first separating assembly output. The first warming assembly also includes a warming unit configured to convert the ice slurry to a first liquid output. The first warming assembly also includes a first warming assembly output configured to provide the first liquid output.

Various terms used herein have special meanings within the present technical field. Whether a particular term should be construed as such a “term of art” depends on the context in which that term is used. Such terms are to be construed in light of the context in which they are used in the present disclosure and as one of ordinary skill in the art would understand those terms in the disclosed context. The above definitions are not exclusive of other meanings that might be imparted to those terms based on the disclosed context.

Additionally, the section headings and topic headings herein are provided for consistency with the suggestions under various patent regulations and practice, or otherwise to provide organizational cues. These headings shall not limit or characterize the embodiments set out in any claims that may issue from this disclosure. Specifically, a description of a technology in the “Background” is not to be construed as an admission that technology is prior art to any embodiments in this disclosure. Furthermore, any reference in this disclosure to “invention” in the singular should not be used to argue that there is only a single point of novelty in this disclosure. Multiple inventions may be set forth according to the limitations of the claims issuing from this disclosure, and such claims accordingly define the invention(s), and their equivalents, that are protected thereby. In all instances, the scope of such claims shall be considered on their own merits in light of this disclosure, but should not be constrained by the headings herein.

### BRIEF DESCRIPTION OF THE FIGURES

For a more complete understanding of the present disclosure, example embodiments, and their advantages, reference is now made to the following description taken in conjunction with the accompanying figures, in which like reference numbers indicate like features, and:

FIG. 1 illustrates an example embodiment of a system for managing aqueous effluent;

FIG. 2 illustrates a relation between the chemical oxygen demand (COD) (represented on the vertical or y-axis, in mg/L) and the isopropyl alcohol (IPA) concentration (represented on the horizontal or x-axis, in vol. %) in an aqueous effluent;

FIG. 3 illustrates a relation between the freezing point of the isopropyl alcohol (IPA) (represented on the vertical or y-axis, in ° C.) and the isopropyl alcohol (IPA) concentration (represented on the horizontal or x-axis, in vol. %) in an aqueous effluent;

FIG. 4 illustrates an example embodiment of a method for managing an aqueous effluent with a second stage of freeze concentration;

FIG. 5 illustrates a relation between the chemical oxygen demand (COD) (represented on the vertical or y-axis, in mg/L) and the isopropyl alcohol (IPA) concentration (represented on the horizontal or x-axis, in vol. %) in a concentrated isopropyl alcohol; and

FIG. 6 illustrates a relation between the freezing point of the isopropyl alcohol (IPA) (represented on the vertical or y-axis, in ° C.) and the isopropyl alcohol (IPA) concentration (represented on the horizontal or x-axis, in vol. %) in a concentrated isopropyl alcohol.

Although similar reference numbers may be used to refer to similar elements in the figures for convenience, it can be appreciated that each of the various example embodiments may be considered distinct variations. Example embodiments will now be described with reference to the accompanying figures, which form a part of the present disclosure and which illustrate example embodiments which may be practiced. As used in the present disclosure and the appended claims, the terms “embodiment”, “example embodiment”, “exemplary embodiment”, and “present embodiment” do not necessarily refer to a single embodiment, although they may, and various example embodiments may be readily combined and/or interchanged without departing from the scope or spirit of example embodiments. Furthermore, the terminology as used in the present disclosure and the appended claims is for the purpose of describing example embodiments only and is not intended to be limitations. In this respect, as used in the present disclosure and the appended claims, the term “in” may include “in” and “on”, and the terms “a”, “an”, and “the” may include singular and plural references. Furthermore, as used in the present disclosure and the appended claims, the term “by” may also mean “from,” depending on the context. Furthermore, as used in the present disclosure and the appended claims, the term “if” may also mean “when” or “upon”, depending on the context. Furthermore, as used in the present disclosure and the appended claims, the words “and/or” may refer to and encompass any and all possible combinations of one or more of the associated listed items.

### DETAILED DESCRIPTION

Present example embodiments relate generally to and/or include systems, subsystems, processors, devices, methods, and processes for addressing conventional problems, including those described above and in the present disclosure, and more specifically, example embodiments relate to systems, subsystems, processors, devices, methods, and processes for treating an aqueous effluent containing isopropyl alcohol.

Example embodiments will now be described below with reference to the accompanying figures, which form a part of the present disclosure.

### Example Embodiments of a System for Managing an Aqueous Effluent (e.g., System 100)

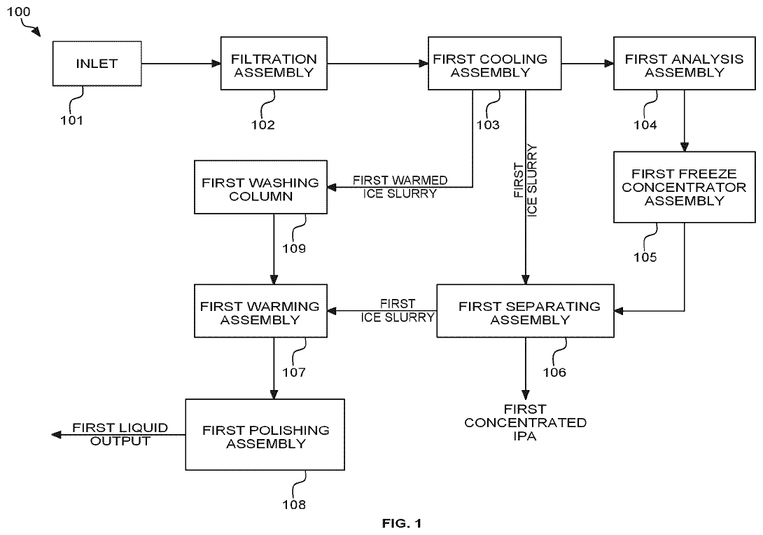

FIG. 1 illustrates an example embodiment of a system (e.g., system 100) for managing an aqueous effluent. The aqueous effluent may be an aqueous effluent containing isopropyl alcohol, or the like. As described in the present disclosure, the system 100 is configurable or configured to perform such management by performing one or more of a variety functions, actions, and/or processes using one or more of the elements described in the present disclosure.

In an example embodiment, the system 100 is configurable or configured to manage an aqueous effluent. The aqueous effluent may contain isopropyl alcohol, suspended solids, ammonia, other dissolved solids, or the like. The system includes an inlet 101, or the like, configurable or configured to receive the aqueous effluent into the system. For example, the inlet 101 may receive the aqueous effluent from waterways, pipes, or the like, that connects from an area, catchment area, pond, and/or industrial wastewater generated from, other sources (e.g., microelectronics industry, mining industry, and any other industries that may generate similar industrial wastewater). The inlet 101 may also be and/or include a collection area, tank, or the like. In such an example, the aqueous effluent to be treated may be collected, fed and/or stored prior to feeding the aqueous effluent into the system.

The system 100 further includes a filtration assembly 102, or the like. The filtration assembly 102 may be configurable or configured to perform a variety of functions, including the filtering or removing of impurities present in the aqueous effluent. The filtration assembly 102 may include a filtration assembly input, or the like, configurable or configured to receive the aqueous effluent provided by the inlet. The filtration assembly 102 may also include a filter unit, or the like. The filter unit may be configurable or configured to filter or remove impurities including, but not limited to, particulate matter, sediments, solids, any suspended matters so as to produce a filtered aqueous effluent. The filtration assembly 102 may include a chemical treatment unit configurable or configured to remove impurities including, but not limited to, oxidizing agents such as hydrogen peroxide. In some such embodiments, the chemical treatment unit is configured or configurable to add a chemical such as sodium metabisulfite, sodium bisulfite, sodium hydroxide, sodium hypochlorite, and/or an enzyme to the aqueous effluent in order to remove impurities. In an example embodiment, the filter unit includes a pre-filtration unit or system, or the like. The pre-filtration unit or system may be or include, but is not limited to, an ultrafiltration system, reverse osmosis system, cartridge filtration, membrane cartridge filtration, multimedia filtration, and any other suitable filtration systems which may be used. The filtration assembly 102 may also include a filtration assembly output, or the like, configurable or configured to provide the filtered aqueous effluent to a first cooling assembly 103 for further processing.

The system 100 also includes a first cooling assembly 103, or the like. The first cooling assembly 103 may be configurable or configured to perform a variety of functions, including reducing of a temperature (and/or removing of heat, cooling, or the like; collectively, “reducing a temperature”) of the filtered aqueous effluent. The first cooling assembly 103 may include a first cooling assembly input, or the like, configurable or configured to receive the filtered aqueous effluent from the filtration assembly. The first cooling assembly 103 may also include a first cooling unit, or the like. The first cooling unit may be configurable or configured to perform a variety of functions, including the reducing of a temperature of the received filtered aqueous effluent so as to arrive at a first cooled aqueous effluent. In an example embodiment, the first cooling unit may be a closed loop system, or the like, configurable or configured to reduce the temperature of the filtered aqueous effluent. In some embodiments, the first cooling unit may comprise a heat pump configurable or configured to remove heat from the filtered aqueous effluent. In some embodiments, the first cooling unit may also comprise a refrigeration cycle configurable or configured to remove heat from the filtered aqueous effluent. The first cooling unit may include a first heat exchanger, or the like, configurable or configured to reduce temperature and/or transfer heat or energy from the received filtered aqueous effluent into a coolant, or the like. Examples of suitable heat exchangers for a cooling unit that may be used in the present disclosure includes, but not limited to, shell and tube heat exchanger, tube-to-fin exchanger, plate and frame heat exchangers, plate fin heat exchangers, and any other suitable heat exchangers which may be used. The first heat exchanger may be configurable or configured to receive an ice slurry (e.g., first ice slurry) from a first separating assembly as the coolant when reducing the temperature of the received filtered aqueous effluent. The first ice slurry from the first separating assembly may be ice slurry produced from one or more previous cycles of treating the aqueous effluent and/or from other systems 100. Further, the coolant may also include, but not limited to, methanol, ethanol, a combination of methanol and ethanol, glycol, polyethylene glycols and any other suitable coolant which may be used. When the first cooling unit receives the filtered aqueous effluent, the aqueous effluent may flow on the exterior or the outside of the tubes or plates of the first heat exchanger. In such an example, the coolant will flow through the interior or the inside of the tubes or plates of the first heat exchanger. The temperature of the filtered aqueous effluent may be reduced by the transfer of heat from the filtered aqueous effluent to the coolant circulating through or in the first cooling unit. The first cooling assembly 103 may also include a first cooling assembly output, or the like, configurable or configured to provide the cooled aqueous effluent to a first analysis assembly 104 and/or to a first freeze concentrator assembly.

According to some embodiments, the system 100 may further includes a first analysis assembly 104, or the like. The first analysis assembly 104 may be configurable or configured to perform a variety of functions, including the receiving of a first analysis influent stream selected from the aqueous effluent, the filtered aqueous effluent and/or the first cooled aqueous effluent for further processing. The first analysis assembly 104 may include a first analysis assembly input configurable or configured to receive the first analysis influent stream. The first analysis assembly 104 may also include a first chemical oxygen demand (COD) analyzer, or the like. As would be familiar to those skilled in the art, chemical oxygen demand (COD) is a determination of the quantity of oxygen that could be consumed by constituent reactants in a solution, expressed as milligrams of oxygen consumed per liter of solution. The first chemical oxygen demand (COD) analyzer may be configurable or configured to determine a first concentration of chemical oxygen demand (COD) in the first analysis influent stream received by the first analysis assembly input. When the first analysis influent stream is received from the first cooling assembly, the first chemical oxygen demand (COD) analyzer may be configurable or configured to determine the first chemical oxygen demand (COD) and provide real-time information on the chemical oxygen demand (COD) concentration. Additionally or alternatively, the first analysis assembly 104 may also receive a predetermined concentration of the chemical oxygen demand (COD) in the first analysis influent stream. For example, the first concentration of the chemical oxygen demand (COD) may be one or more predetermined concentrations that are determined or obtained from available sources. The first concentration of the chemical oxygen demand (COD) may be one or more predetermined concentrations that are determined or obtained based on previous managements on a first cooled aqueous effluent. As another example, the predetermined concentrations may be a preset concentration of chemical oxygen demand (COD) of a first analysis influent stream from a previous treatment and/or retrieved from a first operation temperature processor before starting the process of managing the first analysis influent stream. As another example, the aqueous effluent to be managed may be from a known or historic source. If the aqueous effluent to be managed is from a known or historic source, the first operation temperature processor (as further described in the present disclosure) may retrieve and/or receive the predetermined concentrations of the chemical oxygen demand (COD) based on previous management of the aqueous effluent from the same known or historic source. Other approaches to obtaining predetermined concentrations of the chemical oxygen demand (COD) are also contemplated without departing from the teachings of the present disclosure.

According to some embodiments, the first analysis assembly 104 may further includes a first total organic carbon (TOC) analyzer, or the like. The first total organic carbon (TOC) analyzer may be configurable or configured to determine a first concentration of total organic carbon (TOC) in the first analysis influent stream received by the first analysis assembly input. Total organic carbon is the concentration of carbon contained in organic compounds in a solution, expressed as milligrams of carbon per liter of solution. The first total organic carbon (TOC) analyzer is configurable or configured to determine a concentration of carbon in organic compounds in the first analysis influent stream. When the first analysis assembly 104 receives the first analysis influent stream, the first total organic carbon (TOC) analyzer may be configurable or configured to determine the total organic carbon (TOC) and provide real-time information on the total organic carbon (TOC) concentration. Additionally or alternatively, the first analysis assembly 104 may also receive a predetermined concentration of the first total organic carbon (TOC) in the first analysis influent stream. For example, the first concentration of the total organic carbon (TOC) may be one or more predetermined concentrations that are determined or obtained from available sources. As another example, the first concentration of the total organic carbon (TOC) may be one or more predetermined concentrations that are determined or obtained based on previous managements on the aqueous effluent. As another example, the predetermined concentrations may be a preset concentration of total organic carbon (TOC) of a first analysis influent stream from a previous management and/or retrieved from the first operation temperature processor (as described in the present disclosure) before starting the process of managing the first analysis influent stream. As another example, the aqueous effluent to be managed may be from a known or historic source. If the aqueous effluent to be managed is from the known or historic source, the first operation temperature processor may retrieve and/or receive the predetermined concentrations of the total organic carbon (TOC) based on previous management of the aqueous effluent from the same known or historic source. Other approaches to obtaining predetermined concentrations of the total organic carbon (TOC) are also contemplated without departing from the teachings of the present disclosure.

According to some embodiments, the first analysis assembly 104 may further include a first operation temperature processor, or the like. The first operation temperature processor may be configurable or configured to determine a first operation temperature for a first freeze concentrator assembly 105. The first operation temperature may be determined based on, among other things, the first concentration of chemical oxygen demand (COD) determined by the chemical oxygen demand (COD) analyzer. As such, the first operation temperature processor may be configurable or configured to receive the first concentration of the chemical oxygen demand (COD) of the first analysis influent stream from the first chemical oxygen demand (COD) analyzer. When the first operation temperature processor receives and processes the first concentration received from the first chemical oxygen demand (COD) analyzer, the first operation temperature processor may be configurable or configured to determine a first concentration of isopropyl alcohol in the first analysis influent stream based on the results (e.g., concentrations) of the chemical oxygen demand (COD) analyzer.

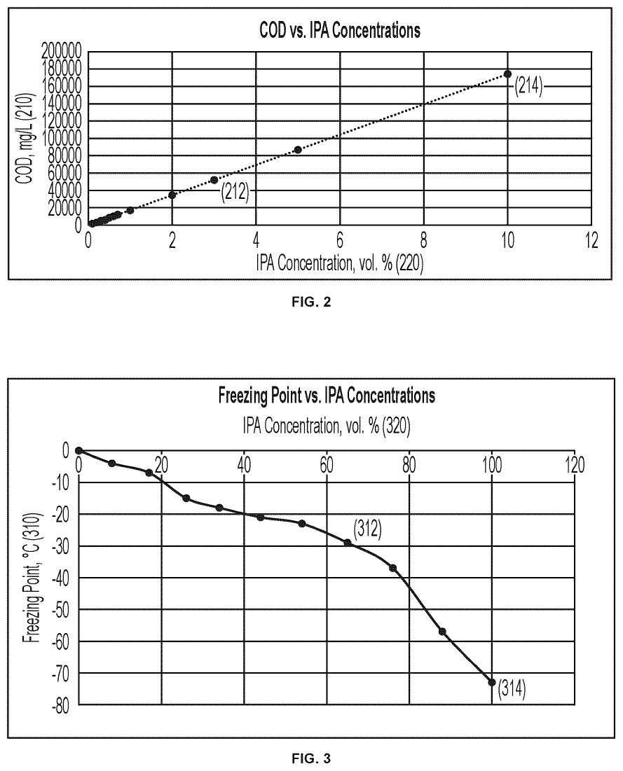

When the first operation temperature processor receives and processes the first concentration received from the first chemical oxygen demand (COD) analyzer, the first operation temperature processor may be configurable or configured to determine a first concentration of isopropyl alcohol in the first analysis influent stream based on the results (e.g., concentrations) of the chemical oxygen demand (COD) analyzer. FIG. 2 illustrates example relations between the chemical oxygen demand (COD) 210 (represented on the vertical or y-axis, in mg/L) and the isopropyl alcohol (IPA) concentration 220 (represented on the horizontal or x-axis, in vol. %) in an analysis influent stream. As illustrated, the concentration of an isopropyl alcohol increases linearly as the concentration of the chemical oxygen demand (COD) increases. Referring to the example relationship illustrated in FIG. 2, when the first operation temperature processor receives a concentration of the chemical oxygen demand (COD) of 50,000 mg/L in the first analysis influent stream, the first operation temperature processor may be configurable or configured to determine the concentration of the first concentration of isopropyl alcohol in the first analysis influent stream to be 3 vol. % (see data point 212 in FIG. 2) based on the relationship. Referring to another example relationship illustrated in FIG. 2, when the first operation temperature processor receives a concentration of the chemical oxygen demand (COD) of 170,000 mg/L in the first analysis influent stream, the first operation temperature processor is configurable or configured to determine the concentration of the first concentration of isopropyl alcohol in the first analysis influent stream to be 10 vol. % (see data point 214 in FIG. 2) based on the relationship.

The first operation temperature may be determined based on, among other things, the first concentration of total organic carbon (TOC) determined by the total organic carbon (TOC) analyzer. As such, the first operation temperature processor may be configurable or configured to receive the first concentration of the total organic carbon (TOC) of the first analysis influent stream from the first total organic carbon (TOC) analyzer. When the first operation temperature processor receives and processes the first concentration received from the first total organic carbon (TOC) analyzer, the first operation temperature processor may be configurable or configured to determine a first concentration of isopropyl alcohol in the first analysis influent stream based on, among other things, the results (e.g., concentrations) of the total organic carbon (TOC) analyzer. A molecule of isopropyl alcohol has a molecular weight of 60.1 Da and contains 3 carbon atoms, these carbon atoms having combines molecular weight of 36.033. Therefore, isopropyl alcohol is about 60% organic carbon. Based on this relationship, the concentration of isopropyl alcohol can be estimated from the concentration of total organic carbon (TOC) determined by the TOC analyzer by dividing the result by 60%. According to some embodiments, when the first operation temperature processor receives a concentration of total organic carbon (TOC) of 100,000 mg/L in the first analysis influent stream, the first operation temperature processor may be configurable or configured to determine the concentration of the first concentration of isopropyl alcohol in the first analysis influent stream to be 160,000 mg/L, or approximately 16%, assuming a solution density of 1 kg/L. In other embodiments, the relationship between total organic carbon (TOC) and concentration of isopropyl alcohol may be estimated or extrapolated from other known relationships between total organic carbon (TOC) and isopropyl alcohol concentrations for previous or historic sources of first analysis influent stream.

Once the first concentration of isopropyl alcohol in the first analysis influent stream is determined, the first operation temperature processor may be further configurable or configured to determine the first operation temperature for a first freeze concentrator assembly 105 (i.e., a first operation temperature to be used by the first freeze concentrator assembly) based on the determined first concentration of isopropyl alcohol. Additionally or alternatively, the first operation temperature processor may also determine a first concentration of the isopropyl alcohol in the first analysis influent stream based on predetermined concentrations of the isopropyl alcohol. For example, the concentration of the isopropyl alcohol may be one or more predetermined concentrations that are determined or obtained based on previous managements on the aqueous effluent. As another example, the predetermined concentrations may be a preset concentration of isopropyl alcohol of a first analysis influent stream from a previous management and/or retrieved from the first operation temperature processor before starting the process of managing the said aqueous effluent. As another example, the aqueous effluent to be managed may be from a known or historic source. If the aqueous effluent to be treated is from the known or historic source, the first operation temperature processor may retrieve and/or receive the predetermined concentration of the isopropyl alcohol based on previous management of the aqueous effluent from the same known or historic source. Other approaches to obtaining predetermined concentrations of the isopropyl alcohol are also contemplated without departing from the teachings of the present disclosure.

Once the first concentration of isopropyl alcohol in the first analysis influent stream is determined, the first operation temperature processor may be further configurable or configured to determine the first operation temperature for a first freeze concentrator assembly 105 based on the determined first concentration of isopropyl alcohol as described above. According to some embodiments, depending on the first concentration of isopropyl alcohol which has been determined, the first operation temperature (e.g., freezing point) for the first freeze concentrator assembly 105 may be determined based on the freezing point of a solution containing isopropyl alcohol, as illustrated in FIG. 3. According to some such embodiments, the first operation temperature processor may also be configurable or configured to communicate the first operation temperature to the first freeze concentrator. FIG. 3 illustrates example relations between the freezing point of the isopropyl alcohol (IPA) 310 (represented on the vertical or y-axis, in ° C.) and the isopropyl alcohol (IPA) concentration 320 (represented on the horizontal or x-axis, in vol. %) in an aqueous effluent. Referring to the example relationship illustrated in FIG. 3, the first operation temperature processor will be set at a much lower temperature (freezing point) as the concentration of the isopropyl alcohol (IPA) concentration increases in order to concentrate the isopropyl alcohol (IPA) that is present in the first cooled aqueous effluent. For example, the first operation (e.g., freezing point) for an aqueous effluent with a 65 vol. % of isopropyl alcohol is −29° C. (see data point 312 in FIG. 3). The temperature of the first freeze concentrator assembly 105 will then be set at −29° C., allowing the first freeze concentrator to convert liquid (e.g., water) into solids (e.g., ice crystals) and to concentrate the isopropyl alcohol in the first cooled aqueous effluent. In another example relationship, the first operation temperature (e.g., freezing point) for an aqueous effluent with a 100 vol. % of isopropyl alcohol is −73° C. (see data point 314 in FIG. 3). The temperature of the first freeze concentrator assembly 105 will then be set at −73° C., allowing the first freeze concentrator to convert liquid (e.g., water) into solids (e.g., ice crystals) and to concentrate the isopropyl alcohol in the first cooled aqueous effluent.

According to another embodiment of the invention, the temperature of the first freeze concentrator 105 may be set to a temperature below the temperature determined by the relationship between the freeing point of isopropyl alcohol and the concentration of isopropyl alcohol illustrated in FIG. 3. According to some such embodiments, setting the temperature of the first freeze concentrator (105) below the freezing point of the isopropyl alcohol solution may increase process kinetics. According to some embodiments, the temperature may be set at least 0.1° C., 0.5° C., 1° C., 2°° C., 3° C., 4° C., 5° C., 10° C., or at least more than 10° C. below the freezing point of the analysis influent stream as determined by the first operation temperature processor based on the relationship illustrated in FIG. 3.

The first analysis assembly 104 may also include a first analysis assembly output, or the like, configurable or configured to provide the operation temperature determined by the first operation temperature processor to the first freeze concentrator assembly 105. Alternatively or in addition, the first analysis assembly output may also be configurable or configured to provide the first cooled aqueous effluent received by the first analysis assembly input to the first freeze concentrator assembly 105.

The system 100 further includes a first freeze concentrator assembly 105, or the like. The first freeze concentrator assembly 105 may be configurable or configured to perform a variety of functions, including the reducing of the temperature of the first cooled aqueous effluent to produce a first solution of first ice slurry and first concentrated isopropyl alcohol. The first freeze concentrator assembly 105 may include a first freeze concentrator input, or the like, configurable or configured to receive the first cooled aqueous effluent from the first analysis assembly 104 and/or from the first cooling assembly. The first freeze concentrator assembly 105 may also include a first freeze concentrator. The first freeze concentrator may be configurable or configured to convert the first cooled aqueous effluent received by the first freeze concentrator assembly input to a first solution of first ice slurry and first concentrated isopropyl alcohol. The first freeze concentrator may be configurable or configured to perform such conversion by reducing the temperature of (and/or removing heat from, etc.) the first cooled aqueous effluent. During the conversion, the first freeze concentrator may be configurable or configured to remove liquid (e.g., water) from first cooled aqueous effluent by converting them into solids (e.g., ice crystals) (e.g., by cooling and/or freezing the first cooled aqueous effluent using a coolant to circulate the first freeze concentrator). The ice crystals and water from the ice slurry that is in the first solution of first ice slurry and first concentrated isopropyl alcohol. The first freeze concentrator assembly 105 may also include a first freeze concentrator assembly output, or the like, configurable or configured to provide the first solution of first ice slurry and first concentrated isopropyl alcohol to a first separating assembly 106.

The system 100 further includes a first separating assembly 106, or the like. The first separating assembly 106 may be configurable or configured to separate the first ice slurry and the first concentrated isopropyl alcohol in the first solution of first ice slurry and first concentrated isopropyl alcohol. The first separating assembly 106 may include a first separating assembly input configurable or configured to receive the first solution of first ice slurry and first concentrated isopropyl alcohol from the first freeze concentrator assembly output. The first separating assembly 106 may further include a first separating unit, or the like, configurable or configured to separate the ice slurry from the concentrated isopropyl alcohol in the first solution of first ice slurry and first concentrated isopropyl alcohol. The first separating unit may be and/or include, but not limited to, a wash column, a centrifuge, a liquid-solid separator, a filtration system, decanter and any other suitable separating unit which may be used. Additionally or alternatively, there may be one or more first separating units in the first separating assembly 106 to perform the separation of the first ice slurry from the first concentrated isopropyl alcohol. Once the first ice slurry is separated from the first concentrated isopropyl, the first separating assembly 106 may be configurable or configured to provide, via a first separating assembly output, at least a portion or all of the obtained first ice slurry to the first heat exchanger in the first cooling assembly. As described in the present disclosure, the heat exchanger may be configurable or configured to receive an ice slurry from a first separating assembly 106 as a coolant when reducing the temperature of the received filtered aqueous effluent. The first separating assembly 106 may also include a first separating assembly output, or the like, configurable or configured to provide at least a portion of the ice slurry to a first warming assembly 107.

The system 100 also includes a first warming assembly 107, or the like. The first warming assembly 107 may be configurable or configured to perform a variety of functions, including the converting of first ice slurry to liquid. The first warming assembly 107 may include a first warming assembly input, or the like, configurable or configured to receive the first ice slurry from the first separating assembly output. The first warming assembly 107 may further include a first warming unit. The first warming unit may be configurable or configured to convert the first ice slurry to a first liquid output. The conversion may be performed by, for example, melting, liquefy, etc. the first ice slurry into liquid (e.g., water products). The first warming unit may be and/or include, but not limited to, an ice crusher, a helical shaped heating system and any other means which may be used in the disclosure. Additionally or alternatively, the first warming assembly 107 may also be configurable or configured to receive the first ice slurry provided to the first cooling unit (e.g., heat exchanger, etc.) of the first cooling assembly. As described in the present disclosure, the first ice slurry is provided to the first cooling unit (e.g., first heat exchanger, etc.) of the first cooling assembly 103 as a coolant to reduce the temperature from the filtered aqueous effluent. The process of reducing the temperature provides a warmed first ice slurry due to heat transfer. Further, the system 100 may also include a first washing column 109, or the like. The first washing column 109 may be configurable or configured to remove surface impurities in the warmed first ice slurry from the first cooling assembly. For example, the first washing column 109 may be configurable or configured to remove impurities, including any surface impurities such as suspended solids, particles, organics, dissolved solids and/or any remaining isopropyl alcohol that is present in the warmed first ice slurry. The warmed first ice slurry may be washed several times in the first washing column 109 to ensure the impurities and/or any remaining isopropyl alcohol is removed from the warmed first ice slurry. The first warming assembly 107 may also include a first warming assembly output, or the like, configurable or configured to provide the first liquid output to the first polishing assembly 108.

The system 100 further includes a first polishing assembly 108, or the like. The first polishing assembly 108 may be configured to perform a variety of functions, including the removal of remaining impurities from liquid. The first polishing assembly 108 may include a polishing assembly input, or the like, configurable or configured to receive, as input, the first liquid output from the first warming assembly output. The first polishing assembly 108 may further include a first polishing unit, or the like. The first polishing unit may be configurable or configured to remove impurities from the first liquid output so as to arrive at a first final output. The first polishing unit may be and/or include conventional nanofiltration (NF) membranes, brackish water reverse osmosis (BWRO) membranes, sea water reverse osmosis (SWRO) membranes and/or any other suitable membranes which may be used. In an example, the first polishing unit may be configurable or configured to remove remaining impurities, including suspended solids, particles, organics and dissolved solids, to meet the reusable water quality and to produce clean or pure first final output which may include water products that has no and/or significantly reduced concentration of isopropyl alcohol. The clean or pure water products are subsequently safely disposed into a water source in the environment, reused in the treatment system where applicable and/or used in any other suitable applications. The retentate (e.g., impurities, etc.) from the first polishing unit may be further processed for disposal using suitable processes or recycled, depending on application. The first polishing assembly 108 may also include a first polishing assembly output, or the like, configurable or configured to provide the first final output.

### Example Embodiments of a System for Managing an Aqueous Effluent (e.g., System 100)

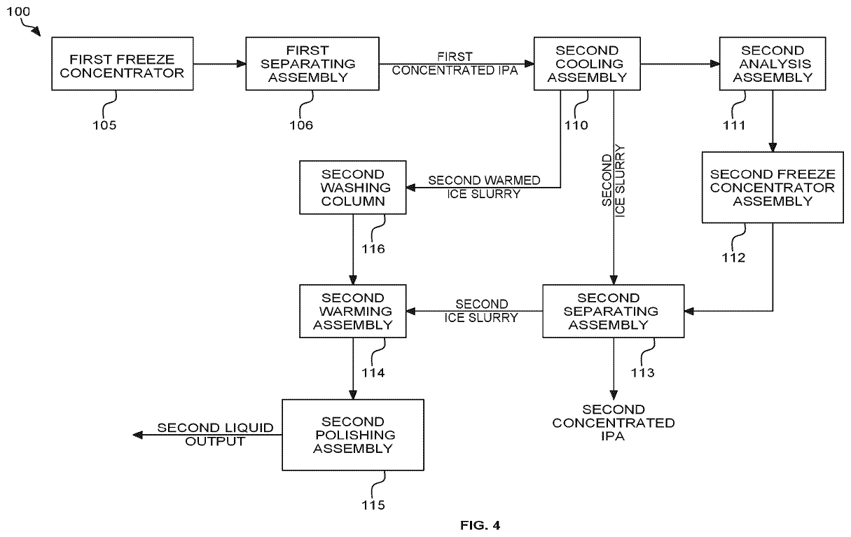

In another example embodiment, the system 100 may also further include a second stage for managing an aqueous effluent. FIG. 4 illustrates an example of a system (e.g., system 100) with a second stage of freeze concentration process. As described in the present disclosure, the system 100 is configurable or configured to perform such management by performing one or more of a variety functions, actions, and/or processes using one or more of the elements described in the present disclosure.

In this example embodiment, the system 100 includes a second cooling assembly 110, or the like. The second cooling assembly 110 may be configurable or configured to perform a variety of functions, including reducing of a temperature (and/or removing of heat, cooling, or the like; collectively, “reducing a temperature”) of the first concentrated isopropyl alcohol. The second cooling assembly 110 may include a second cooling assembly input, or the like, configurable or configured to receive the first concentrated isopropyl alcohol from the first separating assembly. The second cooling assembly 110 may also include a second cooling unit, or the like. The second cooling unit may be configurable or configured to perform a variety of functions, including the reducing of a temperature of the received first concentrated isopropyl alcohol to arrive at a cooled first concentrated isopropyl alcohol. In an example embodiment, the second cooling unit may be a closed loop system, or the like, configurable or configured to reduce the temperature and/or transfer heat or energy from the received first concentrated isopropyl alcohol into a coolant, or the like. In some embodiments, the second cooling unit may comprise a heat pump configurable or configured to remove heat from the filtered aqueous effluent. In some embodiments, the first cooling unit may also comprise a refrigeration cycle configurable or configured to remove heat from the filtered aqueous effluent. The second cooling unit may include a second heat exchanger, or the like, configurable or configured to reduce temperature and/or transfer heat or energy from the received filtered aqueous effluent into a coolant, or the like. Examples of suitable heat exchangers for a cooling unit that may be used in the present disclosure includes, but not limited to, shell and tube heat exchanger, tube-to-fin exchanger, plate and frame heat exchangers, plate fin heat exchangers, and any other suitable heat exchangers which may be used. The second heat exchanger may be configurable or configured to receive an ice slurry (e.g., second ice slurry) from a second separating assembly 113 as the coolant when reducing the temperature of the received first concentrated isopropyl alcohol. The second ice slurry from the second separating assembly 113 may be ice slurry produced from one or more previous cycles of treating the aqueous effluent and/or from other systems 100. Further, the coolant may also include, but not limited to, a methanol, ethanol, a combination of methanol and ethanol, glycol, polyethylene glycols and any other suitable coolant which may be used. When the second cooling unit receives the first concentrated isopropyl alcohol, the first concentrated isopropyl alcohol may flow on the exterior or the outside of the tubes/plates of the heat exchanger. In such an example, the coolant will flow through the interior or the inside of the tubes/plates of the heat exchanger. The temperature of the first concentrated isopropyl alcohol may be reduced by the transfer of heat from the first concentrated isopropyl alcohol to the coolant circulating through or in the second cooling unit. The second cooling assembly 110 may also include a second cooling assembly output, or the like, configurable or configured to provide the first cooled concentrated isopropyl alcohol to a second analysis assembly 111 and/or to a second freeze concentrator assembly.

According to some embodiments, the system 100 may further include a second analysis assembly 111, or the like. The second analysis assembly 111 may be configurable or configured to perform a variety of functions, including the receiving of a second analysis influent stream selected from the first cooled concentrated isopropyl alcohol from the second cooling assembly 110, and/or the first concentrated isopropyl alcohol from the first separating assembly for further processing. The second analysis assembly 111 may include a second analysis assembly input configurable or configured to receive the second analysis influent stream. The second analysis assembly 111 may also include a second chemical oxygen demand (COD) analyzer, or the like. The second chemical oxygen demand (COD) analyzer may be configurable or configured to determine a second concentration of chemical oxygen demand (COD) in the second analysis influent stream received by the second analysis assembly input. When the second analysis influent stream is received, the second chemical oxygen demand (COD) analyzer may be configurable or configured to determine the second chemical oxygen demand (COD) and provide real-time information on the chemical oxygen demand (COD) concentration. Additionally or alternatively, the second analysis assembly 111 may also receive a predetermined concentration of the chemical oxygen demand (COD) in the second analysis influent stream. For example, the second concentration of the chemical oxygen demand (COD) may be one or more predetermined concentrations that are determined or obtained based on previous managements on a second analysis influent. As another example, the predetermined concentrations may be a preset concentration of a second analysis influent stream from a previous management and/or retrieved from a second operation temperature processor before starting the process of managing the second analysis influent. As another example, the first concentrated isopropyl alcohol to be managed may be of an aqueous effluent collected a known or historic source. If the aqueous effluent to be managed is from a known or historic source, the second operation temperature processor (as further described in the present disclosure) may retrieve and/or receive the predetermined concentrations of the chemical oxygen demand (COD) based on previous management of the first concentrated isopropyl alcohol of the aqueous effluent from the same known or historic source. Other approaches to obtaining predetermined concentrations of the chemical oxygen demand (COD) are also contemplated without departing from the teachings of the present disclosure.

According to some embodiments, the second analysis assembly 111 may further include a second total organic carbon (TOC) analyzer, or the like. The second total organic carbon (TOC) analyzer may be configurable or configured to determine a second concentration of total organic carbon (TOC) in the second analysis influent stream received by the second analysis assembly input. The second total organic carbon (TOC) analyzer is configurable or configured to determine a concentration of total organic carbon (TOC) in organic compounds in the second analysis influent stream. When the second analysis assembly 111 receives the second analysis influent stream, the second total organic carbon (TOC) analyzer may be configurable or configured to determine the total organic carbon (TOC) and provide real-time information on the total organic carbon (TOC) concentration. Additionally or alternatively, the second analysis assembly 111 may also receive a predetermined concentration of the second total organic carbon (TOC) in the second analysis influent stream. For example, the concentration of the total organic carbon (TOC) may be one or more predetermined concentrations that are determined or obtained based on previous managements on the first cooled concentrated isopropyl alcohol. As another example, the predetermined concentrations may be a preset concentration of a total organic carbon (TOC) from a previous management and/or retrieved from the second operation temperature processor (as described in the present disclosure) before starting the process of managing the said first cooled concentrated isopropyl alcohol. As another example, the first concentrated isopropyl alcohol to be managed may be of an aqueous effluent collected from a known or historic source. If the aqueous effluent to be managed is from the known or historic source, the second operation temperature processor may retrieve and/or receive the predetermined concentrations of the total organic carbon (TOC) based on previous management of the first concentrated isopropyl alcohol of the aqueous effluent from the same known or historic source. Other approaches to obtaining predetermined concentrations of the total organic carbon (TOC) are also contemplated without departing from the teachings of the present disclosure.

According to some embodiments, the second analysis assembly 111 may further include a second operation temperature processor, or the like. The second operation temperature processor may be configurable or configured to determine a second operation temperature for a second freeze concentrator assembly 112. The second operation temperature may be determined based on, among other things, the second concentration of chemical oxygen demand (COD) determined by the chemical oxygen demand (COD) analyzer. As such, the second operation temperature processor may be configurable or configured to receive the second concentration of the chemical oxygen demand (COD) of the second analysis influent stream from the second chemical oxygen demand (COD) analyzer. When the second operation temperature processor receives and processes the second concentration received from the second chemical oxygen demand (COD) analyzer, the second operation temperature processor may be configurable or configured to determine a second concentration of isopropyl alcohol in the second analysis influent stream based on the results (e.g., concentrations) of the chemical oxygen demand (COD) analyzer.

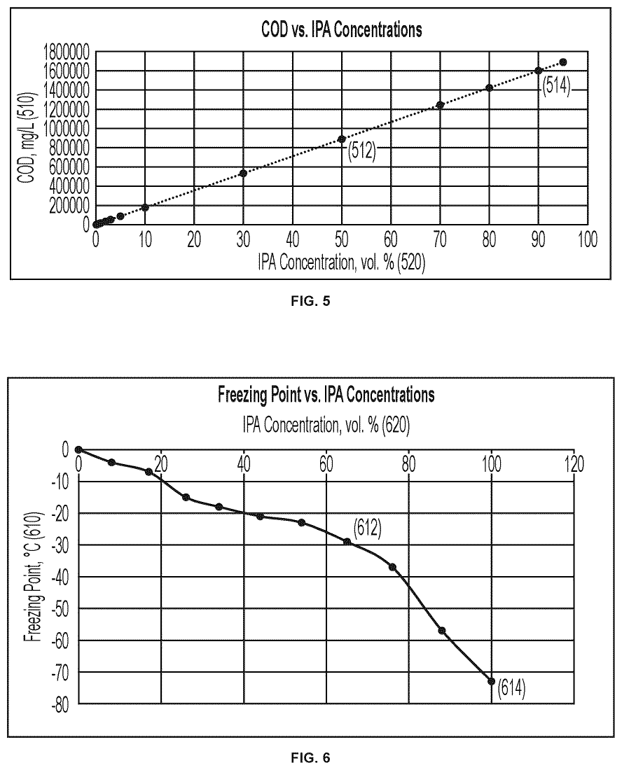

When the second operation temperature processor receives and processes the second concentration received from the second chemical oxygen demand (COD) analyzer, the second operation temperature processor may be configurable or configured to determine a second concentration of isopropyl alcohol in the second analysis influent stream based on the results (e.g., concentrations) of the chemical oxygen demand (COD) analyzer. FIG. 5 illustrates example relations between the chemical oxygen demand (COD) 510 (represented on the vertical or y-axis, in mg/L) and the isopropyl alcohol (IPA) concentration 520 (represented on the horizontal or x-axis, in vol. %) in a concentrated isopropyl alcohol. As illustrated, the concentration of an isopropyl alcohol increases as the concentration of the chemical oxygen demand (COD) increases. Referring to the example relationship illustrated in FIG. 5, when the second operation temperature processor receives a concentration of the chemical oxygen demand (COD) of 900,000 mg/L in the second analysis influent stream, the second operation temperature processor is configurable or configured to determine the concentration of the second concentration of isopropyl alcohol in the second analysis influent stream to be 50 vol. % (see data point 512 in FIG. 5) based on the relationship. Referring to another example relationship illustrated in FIG. 5, when the second operation temperature processor receives a concentration of the chemical oxygen demand (COD) of 1,600,000 mg/L in the second analysis influent stream, the second operation temperature processor is configurable or configured to determine the concentration of the second concentration of isopropyl alcohol in the second analysis influent stream to be 90 vol. % (see data point 514 in FIG. 5) based on the relationship.

The second operation temperature may also be determined based on, among other things, the second concentration of total organic carbon (TOC) determined by the second total organic carbon (TOC) analyzer. As such, the second operation temperature processor may be configurable or configured to receive the second concentration of the total organic carbon (TOC) of the second analysis influent stream from the second total organic carbon (TOC) analyzer. When the second operation temperature processor receives and processes the second concentration received from the second total organic carbon (TOC) analyzer, the second operation temperature processor may be configurable or configured to determine a second concentration of isopropyl alcohol in the second analysis influent stream based on, among other things, the results (e.g., concentrations) of the total organic carbon (TOC) analyzer. A molecule of isopropyl alcohol has a molecular weight of 60.1 Da and contains 3 carbon atoms, these carbon atoms having combines molecular weight of 36.033. Therefore, isopropyl alcohol is about 60% organic carbon. Based on this relationship, the concentration of isopropyl alcohol can be estimated from the concentration of total organic carbon (TOC) determined by the TOC analyzer by dividing the result by 60%. According to some embodiments, when the second operation temperature processor receives a concentration of total organic carbon (TOC) of 100,000 mg/L in the second analysis influent stream, the second operation temperature processor may be configurable or configured to determine the concentration of the second concentration of isopropyl alcohol in the second analysis influent stream to be 160,000 mg/L, or approximately 16%, assuming a solution density of 1 kg/L. In other embodiments, the relationship between total organic carbon (TOC) and concentration of isopropyl alcohol may be estimated or extrapolated from other known relationships between total organic carbon (TOC) and isopropyl alcohol concentrations for previous or historic sources of second analysis influent stream.

Once the second concentration of isopropyl alcohol in the second analysis influent stream is determined, the second operation temperature processor may be further configurable or configured to determine the second operation temperature for a second freeze concentrator assembly 112 (i.e., a first operation temperature to be used by the second freeze concentrator assembly) based on the determined second concentration of isopropyl alcohol. Additionally or alternatively, the second operation temperature processor may also determine a second concentration of the isopropyl alcohol in the second analysis influent stream based on predetermined concentrations of the isopropyl alcohol. For example, the concentration of the isopropyl alcohol may be one or more predetermined concentrations that are determined or obtained based on previous managements on a first cooled concentrated isopropyl alcohol. As another example, the predetermined concentrations may be a preset concentration of isopropyl alcohol of a second analysis influent stream from a previous management and/or retrieved from the second operation temperature processor before starting the process of managing a first cooled concentrated isopropyl alcohol. As another example, the first concentrated isopropyl alcohol to be managed may be of an aqueous effluent collected from a known or historic source. If the aqueous effluent to be managed is from the known or historic source, the second operation temperature processor may retrieve and/or receive the predetermined concentrations of the chemical oxygen demand (COD) and/or concentration total organic carbon (TOC) based on previous management of the first concentrated isopropyl from the same known or historic source. Other approaches to obtaining predetermined concentrations of the isopropyl alcohol are also contemplated without departing from the teachings of the present disclosure.

Once the second concentration of isopropyl alcohol in the second analysis influent stream is determined, the second operation temperature processor may be further configurable or configured to determine the second operation temperature for a second freeze concentrator assembly 112 based on the determined second concentration of isopropyl alcohol as described above. According to some embodiments, depending on the second concentration of isopropyl alcohol which has been determined, the second operation temperature (e.g., freezing point) for the second freeze concentrator assembly 112 may be determined based on the freezing point of a solution containing isopropyl alcohol, as illustrated in FIG. 6. The second operation temperature processor may also be configurable or configured to communicate the second operation temperature to the second freeze concentrator. FIG. 6 illustrates example relations between the freezing point of the isopropyl alcohol (IPA) 610 (represented on the vertical or y-axis, in ° C.) and the isopropyl alcohol (IPA) concentration 620 (represented on the horizontal or x-axis, in vol. %) in a concentrated isopropyl alcohol. As illustrated, the second operation temperature processor will be set at a much lower temperature (freezing point) as the concentration of the isopropyl alcohol (IPA) concentration increases in order to concentrate the isopropyl alcohol (IPA) that is present in the first cooled concentrated isopropyl alcohol. For example, the second operation (e.g., freezing point) for a concentrated isopropyl alcohol with a 65 vol. % of isopropyl alcohol is −29° C. (see data point 612 in FIG. 6). The temperature of the second freeze concentrator assembly 112 will then be set at −29° C., allowing the second freeze concentrator to convert liquid (e.g., water) into solids (e.g., ice crystals) and to concentrate the isopropyl alcohol in the first cooled isopropyl alcohol. In another example relationship, the second operation temperature (e.g., freezing point) for a concentrated isopropyl alcohol with a 100 vol. % of isopropyl alcohol is −73° C. (see data point 614 in FIG. 6). The temperature of the second freeze concentrator assembly 112 will then be set at −73° C., allowing the second freeze concentrator to convert liquid (e.g., water) into solids (e.g., ice crystals) and to concentrate the isopropyl alcohol in the first cooled concentrated isopropyl alcohol.

According to another embodiment of the invention, the temperature of the second freeze concentrator 112 may be set to a temperature below the temperature determined by the relationship between the freeing point of isopropyl alcohol and the concentration of isopropyl alcohol illustrated in FIG. 6. According to some such embodiments, setting the temperature of the second freeze concentrator 112 below the freezing point of the isopropyl alcohol solution may increase process kinetics. According to some embodiments, the temperature may be set at least 0.1° C., 0.5° C., 1° C., 2° C., 3° C., 4° C., 5° C., 10° C., or at least more than 10° C. below the freezing point of the second analysis influent stream as determined by the second operation temperature processor based on the relationship illustrated in FIG. 6.

The second analysis assembly 111 may also include a second analysis assembly output, or the like, configurable or configured to provide the second operation temperature determined by the second operation temperature processor to the second freeze concentrator assembly 112. Alternatively or in addition, the second analysis assembly output may also be configurable or configured to provide the second analysis influent stream received by the second analysis assembly 111 input to the second freeze concentrator assembly 112.

The system 100 further includes a second freeze concentrator assembly 112, or the like. The second freeze concentrator assembly 112 may be configurable or configured to perform a variety of functions, including the reducing of the temperature of the first cooled concentrated isopropyl alcohol to produce a second solution of second ice slurry and second concentrated isopropyl alcohol. The second freeze concentrator assembly 112 may include a second freeze concentrator input, or the like, configurable or configured to receive the first cooled concentrated isopropyl alcohol from the second analysis assembly 111 and/or the second cooling assembly 110. The second freeze concentrator assembly 112 may also include a second freeze concentrator. The second freeze concentrator may be configurable or configured to convert the first cooled concentrated isopropyl alcohol received by the second freeze concentrator assembly input to a second solution of second ice slurry and second concentrated isopropyl alcohol. The second freeze concentrator may be configurable or configured to perform such conversion by reducing the temperature of (and/or removing heat from, etc.) the first cooled concentrated isopropyl alcohol. During the conversion, the second freeze concentrator is configurable or configured to remove liquid (e.g., water) from first cooled concentrated isopropyl alcohol by converting them into solids (e.g., ice crystals) (e.g., by cooling and/or freezing the first cooled concentrated isopropyl alcohol using a coolant to circulate the second freeze concentrator). The ice crystals and water forms the ice slurry that is in the second solution of second ice slurry and second concentrated isopropyl alcohol. The second freeze concentrator assembly 112 may also include a second freeze concentrator assembly output, or the like, configurable or configured to provide the second solution of second ice slurry and second concentrated isopropyl alcohol to a second separating assembly 113.

The system 100 further includes a second separating assembly 113, or the like. The second separating assembly 113 may be configurable or configured to separate the second ice slurry and the second concentrated isopropyl alcohol in the second solution of second ice slurry and second concentrated isopropyl alcohol. The second separating assembly 113 may include a second separating assembly input configurable or configured to receive the second solution of second ice slurry and second concentrated isopropyl alcohol from the second freeze concentrator assembly output. The second separating assembly 113 may further include a second separating unit, or the like, configurable or configured to separate the ice slurry from the concentrated isopropyl alcohol in the second solution of second ice slurry and second concentrated isopropyl alcohol. The second separating unit may be and/or include, but not limited to, a wash column, a centrifuge, a liquid-solid separator, a filtration system, decanter and any other suitable separating unit which may be used. Additionally or alternatively, there may be one or more second separating units in the second separating assembly 113 to perform the separation of the second ice slurry from the second concentrated isopropyl alcohol. Once the second ice slurry is separated from the second concentrated isopropyl, the second separating assembly may be configurable or configured to provide, via a second separating assembly output, at least a portion or all of the obtained second ice slurry to the second heat exchanger in the second cooling assembly. As described in the present disclosure, the second heat exchanger may be configurable or configured to receive an ice slurry from a second separating assembly 113 as a coolant when reducing the temperature of the received first concentrated isopropyl alcohol. The second separating assembly 113 may also include a second separating assembly output, or the like, configurable or configured to provide at least a portion of the ice slurry to a second warming assembly 114.

The system 100 also includes a second warming assembly 114, or the like. The second warming assembly 114 may be configurable or configured to perform a variety of functions, including the converting of second ice slurry to liquid. The second warming assembly 114 may include a second warming assembly input, or the like, configurable or configured to receive the second ice slurry from the second separating assembly output. The second warming assembly 114 may further include a second warming unit. The second warming unit may be configurable or configured to convert the second ice slurry to a second liquid output. The conversion may be performed by, for example, melting, liquefy, etc. the second ice slurry into liquid (e.g., water products). The second warming unit may be and/or include, but not limited to, an ice crusher, a helical shaped heating system and any other means which may be used in the disclosure. Additionally or alternatively, the second warming assembly 114 may also be configurable or configured to receive the second ice slurry provided to the second cooling unit (e.g., heat exchanger, etc.) of the second cooling assembly. As described in the present disclosure, the second ice slurry is provided to the second cooling unit (e.g., heat exchanger, etc.) of the second cooling assembly as a coolant to reduce the temperature of the first concentrated isopropyl alcohol. The process of reducing the temperature provides a warmed second ice slurry due to heat transfer.

Further, the system 100 may also include a second washing column 116, or the like. The second washing column 116 may be configurable or configured to remove surface impurities in the warmed second ice slurry from the second cooling assembly. For example, the second washing column 116 may be configurable or configured to remove impurities including any surface impurities such as suspended solids, particles, organics, dissolved solids and/or any remaining isopropyl alcohol that is present in the warmed second ice slurry. The warmed second ice slurry may be washed several times in the second washing column 116 to ensure the impurities and/or any remaining isopropyl alcohol is removed from the warmed second ice slurry. The second warming assembly 114 may also include a second warming assembly output, or the like, configurable or configured to provide the second liquid output to a second polishing assembly 115.

The system 100 further includes a second polishing assembly 115, or the like. The second polishing assembly may be configured to perform a variety of functions, including the removal of remaining impurities from liquid. The second polishing assembly 115 may include a polishing assembly input, or the like, configurable or configured to receive, as input, the second liquid output from the second warming assembly output. The second polishing assembly 115 may further include a second polishing unit, or the like. The second polishing unit may be configurable or configured to remove impurities from the second liquid output so as to arrive at a second final output. The second polishing unit may be and/or include conventional nanofiltration (NF) membranes, brackish water reverse osmosis (BWRO) membranes, sea water reverse osmosis (SWRO) membranes and/or any other suitable membranes which may be used. In an example, the second polishing unit may be configurable or configured to remove remaining impurities, including suspended solids, particles, organics, dissolved solids, etc. to produce clean or pure second final output which may include water products that has no and/or significantly reduced concentration of isopropyl alcohol. The clean or pure water products are subsequently safely disposed into a water source in the environment, reused in the treatment system where applicable and/or used in any other suitable applications. The retentate (e.g., impurities, etc.) from the second polishing unit may be further processed for disposal using suitable processes or recycled, depending on application. The second polishing assembly 115 may also include a second polishing assembly output, or the like, configurable or configured to provide the second final output.

### Example Embodiments of a Method for Managing an Aqueous Effluent

An example embodiment of a method for managing an aqueous effluent is provided. The aqueous effluent may be an aqueous effluent containing isopropyl alcohol, or the like. One or more actions of method may be performed by one or more elements as described in the present disclosure.

In an example embodiment, the method provides a method for managing an aqueous effluent. The method includes receiving an aqueous effluent. The aqueous effluent may contain isopropyl alcohol, or the like. The aqueous effluent may be received by an inlet 101, or the like, configurable or configured to receive the aqueous effluent into the system. For example, the inlet 101 may receive the aqueous effluent from a waterway, pipes, or the like, that connects from an area, catchment area, pond, and/or industrial wastewater generated from, but not limited to, microelectronics industry, mining industry, and any other industries that may generate similar industrial wastewater. The inlet 101 may also be and/or include a collection area, tank, or the like. In such an example, the aqueous effluent to be treated may be collected, fed and/or stored prior to feeding the aqueous effluent into the system.

The method also includes filtering impurities from the aqueous effluent to arrive at a filtered aqueous effluent. The aqueous effluent may be filtered by a filtration assembly 102, or the like. The filtration assembly 102 may be configurable or configured to perform a variety of functions, including the filtering or removing of impurities present in the aqueous effluent. The filtration assembly 102 may include a filtration assembly input, or the like, to receive the aqueous effluent provided by the inlet. The filtration assembly 102 may also include a filter unit, or the like. The aqueous effluent may be filtered by the filter unit to filter or remove impurities including, but not limited to, particulate matter, sediments, solids, any suspended matters, so as to produce a filtered aqueous effluent. The filtration assembly 102 may include a chemical treatment unit configurable or configured to remove impurities including, but not limited to, oxidizing agents such as hydrogen peroxide. In some such embodiments, the chemical treatment unit is configured or configurable to add a chemical such as sodium metabisulfite, sodium bisulfite, sodium hydroxide, sodium hypochlorite, and/or an enzyme to the aqueous effluent in order to remove impurities. In an example embodiment, the filter unit includes a pre-filtration unit or system, or the like. The pre-filtration unit or system may be or include, but is not limited to, an ultrafiltration system, reverse osmosis system, cartridge filtration, membrane cartridge filtration, multimedia filtration, and any other suitable filtration systems which may be used. The filtration assembly 102 may also include a filtration assembly output, or the like, to provide the filtered aqueous effluent to a first cooling assembly for further processing.

The method further includes reducing a temperature from the received filtered aqueous effluent to arrive at a first cooled aqueous effluent. The temperature of the received filtered aqueous effluent may be reduced by a first cooling assembly 103, or the like. The first cooling assembly 103 may be configurable or configured to perform a variety of functions, including reducing of a temperature (and/or removing of heat, cooling, or the like; collectively, “reducing a temperature”) of the filtered aqueous effluent. The first cooling assembly 103 may include a first cooling assembly input, or the like, to receive the filtered aqueous effluent from the filtration assembly 102. The first cooling assembly 103 may also include a first cooling unit, or the like. The first cooling unit may be configurable or configured to perform a variety of functions, including the reducing of a temperature of the received filtered aqueous effluent so as to arrive at a first cooled aqueous effluent. In an example embodiment, the first cooling unit may be a closed loop system, or the like, configurable or configured to reduce the temperature of the filtered aqueous effluent. In some embodiments, the first cooling unit may comprise a heat pump configurable or configured to remove heat from the filtered aqueous effluent. In some embodiments, the first cooling unit may also comprise a refrigeration cycle configurable or configured to remove heat from the filtered aqueous effluent. The first cooling unit may include a heat exchanger, or the like, configurable or configured to reduce temperature and/or transfer heat or energy from the received filtered aqueous effluent into a coolant, or the like. Examples of suitable heat exchangers for a cooling unit that may be used in the present disclosure includes, but not limited to, shell and tube heat exchanger, tube-to-fin exchanger, plate and frame heat exchangers, plate fin heat exchangers, and any other suitable heat exchangers which may be used. The heat exchanger may be configurable or configured to receive an ice slurry (e.g., first ice slurry) from a first separating assembly 106 as the coolant when reducing the temperature of the received filtered aqueous effluent. The first ice slurry from the first separating assembly 106 may be ice slurry produced from one or more previous cycles of treating the aqueous effluent and/or from other systems 100. Further, the coolant may also include, but not limited to, methanol, ethanol, a combination of methanol and ethanol, glycol, polyethylene glycols and any other suitable coolant which may be used. When the first cooling unit receives the filtered aqueous effluent, the aqueous effluent may flow on the exterior or outside of the tubes/plates of the heat exchanger. In such an example, the coolant will flow through the interior or inside of the tubes/plates of the heat exchanger. The temperature of the filtered aqueous effluent may be reduced by the transfer of heat from the filtered aqueous effluent to the coolant circulating through or in the first cooling unit. The first cooling assembly 103 may also include a first cooling assembly output, or the like, configurable or configured to provide the cooled aqueous effluent to a first analysis assembly 104 and/or to a first freeze concentrator assembly.

According to some embodiments, the method may further include determining a concentration of chemical oxygen demand (COD) in a first analysis influent stream selected from the aqueous effluent, the filtered aqueous effluent and/or the first cooled aqueous effluent. The method of determining a concentration of chemical oxygen demand (COD) may be performed by a first analysis assembly 104, or the like. The first analysis assembly 104 may include a first analysis assembly input to receive the first analysis influent stream. The first analysis assembly 104 may also include a first chemical oxygen demand (COD) analyzer, or the like. The first chemical oxygen demand (COD) analyzer may be configurable or configured to determine a first concentration of chemical oxygen demand (COD) in the first analysis influent stream received by the first analysis assembly input. When the first analysis influent stream is received from the first cooling assembly 103, the first chemical oxygen demand (COD) analyzer determines the first chemical oxygen demand (COD) and provide real-time information on the chemical oxygen demand (COD) concentration. Additionally or alternatively, the first analysis assembly may also receive a predetermined concentration of the chemical oxygen demand (COD) in the first analysis influent stream. For example, the first concentration of the chemical oxygen demand (COD) may be one or more predetermined concentrations that are determined or obtained from available sources. As another example, the first concentration of the chemical oxygen demand (COD) may be one or more predetermined concentrations that are determined or obtained based on previous managements on a first cooled aqueous effluent. As another example, the predetermined concentrations may be a preset concentration of chemical oxygen demand (COD) of a first analysis influent stream from a previous treatment and/or retrieved from a first operation temperature processor before starting the process of managing the said first cooled aqueous effluent. As another example, the aqueous effluent to be managed may be from a known or historic source. If the aqueous effluent to be managed is from a known or historic source, the first operation temperature processor (as further described in the present disclosure) may retrieve and/or receive the predetermined concentrations of the chemical oxygen demand (COD) based on previous management of the aqueous effluent from the same known or historic source. Other approaches to obtaining predetermined concentrations of the chemical oxygen demand (COD) are also contemplated without departing from the teachings of the present disclosure.

According to some embodiments, the method may further include determining a concentration of total organic carbon (TOC) in the first analysis influent stream. The method of determining a concentration of total organic carbon (TOC) may be performed by a first analysis assembly 104, or the like. According to some embodiments, the first analysis assembly 104 includes a first total organic carbon (TOC) analyzer, or the like. The first total organic carbon (TOC) analyzer may be configurable or configured to determine a first concentration of total organic carbon (TOC) in the first analysis influent stream received by the first analysis assembly input. The first total organic carbon (TOC) analyzer determines a concentration of total organic carbon (TOC) in organic compounds in the first analysis influent stream. When the first analysis assembly 104 receives the first analysis influent stream from the first cooling assembly 103, the first total organic carbon (TOC) analyzer may be configurable or configured to determine the total organic carbon (TOC) and provide real-time information on the total organic carbon (TOC) concentration. Additionally or alternatively, the first analysis assembly 104 may also receive a predetermined concentration of the first total organic carbon (TOC) in the first analysis influent stream. For example, the first concentration of the total organic carbon (TOC) may be one or more predetermined concentrations that are determined or obtained from available sources. As another example, the first concentration of the total organic carbon (TOC) may be one or more predetermined concentrations that are determined or obtained based on previous managements on the aqueous effluent. As another example, the predetermined concentrations may be a preset concentration of total organic carbon (TOC) of a first analysis influent stream from a previous management and/or retrieved from the first operation temperature processor (as described in the present disclosure) before starting the process of managing the said aqueous effluent. As another example, the aqueous effluent to be managed may be from a known or historic source. If the aqueous effluent to be managed is from the known or historic source, the first operation temperature processor may retrieve and/or receive the predetermined concentrations of the total organic carbon (TOC) based on previous management of the aqueous effluent from the same known or historic source. Other approaches to obtaining predetermined concentrations of the total organic carbon (TOC) are also contemplated without departing from the teachings of the present disclosure.

According to some embodiments, the method may also include determining an operation temperature for use by a first freeze concentrator assembly 105. The method of determining an operation temperature may be performed by a first analysis assembly 104, or the like. According to some embodiments, the first analysis assembly 104 includes a first operation temperature processor, or the like. The first operation temperature processor may be configurable or configured to determine a first operation temperature for a first freeze concentrator assembly 105. The first operation temperature may be determined based on, among other things, the first concentration of chemical oxygen demand (COD) determined by the chemical oxygen demand (COD) analyzer. As such, the first operation temperature processor may be configurable or configured to receive the first concentration of the chemical oxygen demand (COD) of the first analysis influent stream from the first chemical oxygen demand (COD) analyzer. When the first operation temperature processor receives and processes the first concentration received from the first chemical oxygen demand (COD) analyzer, the first operation temperature processor may be configurable or configured to determine a first concentration of isopropyl alcohol in the first analysis influent stream based on the results (e.g., concentrations) of the chemical oxygen demand (COD) analyzer.

When the first operation temperature processor receives and processes the first concentration received from the first chemical oxygen demand (COD) analyzer, the first operation temperature processor may be configurable or configured to determine a first concentration of isopropyl alcohol in the first analysis influent stream based on the results (e.g., concentrations) of the chemical oxygen demand (COD) analyzer. FIG. 2 illustrates example relations between the relation between the chemical oxygen demand (COD) 210 (represented on the vertical or y-axis, in mg/L) and the isopropyl alcohol (IPA) concentration 220 (represented on the horizontal or x-axis, in vol. %) in an aqueous effluent. As illustrated, the concentration of an isopropyl alcohol increases as the concentration of the chemical oxygen demand (COD) increases. Referring to the example relationship illustrated in FIG. 2, when the first operation temperature processor receives a concentration of the chemical oxygen demand (COD) of 50,000 mg/L in the first analysis influent stream, the first operation temperature processor is configurable or configured to determine the concentration of the first concentration of isopropyl alcohol in the first analysis influent stream to be 3 vol. % (see data point 212 in FIG. 2) based on the relationship. Referring to another example relationship illustrated in FIG. 2, when the first operation temperature processor receives a concentration of the chemical oxygen demand (COD) of 170,000 mg/L in the first analysis influent stream, the first operation temperature processor is configurable or configured to determine the concentration of the first concentration of isopropyl alcohol in the first analysis influent stream to be 10 vol. % (see data point 214 in FIG. 2) based on the relationship.

The first operation temperature may also be determined based on, among other things, the first concentration of total organic carbon (TOC) determined by the total organic carbon (TOC) analyzer. As such, the first operation temperature processor may be configurable or configured to receive the first concentration of the total organic carbon (TOC) of the first analysis influent stream from the first total organic carbon (TOC) analyzer. When the first operation temperature processor receives and processes the first concentration received from the first total organic carbon (TOC) analyzer, the first operation temperature processor may be configurable or configured to determine a first concentration of isopropyl alcohol in the first analysis influent stream based on, among other things, the results (e.g., concentrations) of the total organic carbon (TOC) analyzer. A molecule of isopropyl alcohol has a molecular weight of 60.1 Da and contains 3 carbon atoms, these carbon atoms having combines molecular weight of 36.033. Therefore, isopropyl alcohol is about 60% organic carbon. Based on this relationship, the concentration of isopropyl alcohol can be estimated from the concentration of total organic carbon (TOC) determined by the TOC analyzer by dividing the result by 60%. According to some embodiments, when the first operation temperature processor receives a concentration of total organic carbon (TOC) of 100,000 mg/L in the first analysis influent stream, the first operation temperature processor may be configurable or configured to determine the concentration of the first concentration of isopropyl alcohol in the first analysis influent stream to be 160,000 mg/L, or approximately 16%, assuming a solution density of 1 kg/L. In other embodiments, the relationship between total organic carbon (TOC) and concentration of isopropyl alcohol may be estimated or extrapolated from other known relationships between total organic carbon (TOC) and isopropyl alcohol concentrations for previous or historic sources of first analysis influent stream.

Once the first concentration of isopropyl alcohol in the first analysis influent stream is determined, the first operation temperature processor may be further configurable or configured to determine the first operation temperature for a first freeze concentrator assembly 105 (i.e., a first operation temperature to be used by the first freeze concentrator assembly) based on the determined first concentration of isopropyl alcohol. Additionally or alternatively, the first operation temperature processor may also determine a first concentration of the isopropyl alcohol in the first analysis influent stream based on predetermined concentrations of the isopropyl alcohol. For example, the concentration of the isopropyl alcohol may be one or more predetermined concentrations that are determined or obtained based on previous managements on the aqueous effluent. As another example, the predetermined concentrations may be a preset concentration of isopropyl alcohol of a first analysis influent stream from a previous management and/or retrieved from the first operation temperature processor before starting the process of managing the said aqueous effluent. As another example, the aqueous effluent to be managed may be from a known or historic source. If the aqueous effluent to be treated is from the known or historic source, the first operation temperature processor may retrieve and/or receive the predetermined concentration of the isopropyl alcohol based on previous management of the aqueous effluent from the same known or historic source. Other approaches to obtaining predetermined concentrations of the isopropyl alcohol are also contemplated without departing from the teachings of the present disclosure.

Once the first concentration of isopropyl alcohol in the first analysis influent stream is determined, the first operation temperature processor may determine the first operation temperature for a first freeze concentrator assembly 105 based on the determined first concentration of isopropyl alcohol as described above. According to some embodiments, depending on the first concentration of isopropyl alcohol which has been determined, the first operation temperature (e.g., freezing point) for the first freeze concentrator assembly 105 is determined based on the freezing point of a solution containing isopropyl alcohol, as illustrated in FIG. 3. According to some such embodiments, the first operation temperature processor may also be configurable or configured to communicate the first operation temperature to the first freeze concentrator. FIG. 3 illustrates example relations between the freezing point of the isopropyl alcohol (IPA) 310 (represented on the vertical or y-axis, in ° C.) and the isopropyl alcohol (IPA) concentration 320 (represented on the horizontal or x-axis, in vol. %) in an aqueous effluent. Referring to the example relationship illustrated in FIG. 3, the first operation temperature processor will be set at a much lower temperature (freezing point) as the concentration of the isopropyl alcohol (IPA) concentration increases in order to concentrate the isopropyl alcohol (IPA) that is present in the first cooled aqueous effluent. For example, the first operation (e.g., freezing point) for an aqueous effluent with a 65 vol. % of isopropyl alcohol is −29° C. (see data point 312 in FIG. 3). The temperature of the first freeze concentrator assembly 105 will then be set at −29° C., allowing the first freeze concentrator to convert liquid (e.g., water) into solids (e.g., ice crystals) and to concentrate the isopropyl alcohol in the first cooled aqueous effluent. In another example relationship, the first operation temperature (e.g., freezing point) for an aqueous effluent with a 100 vol. % of isopropyl alcohol is −73° C. (see data point 314 in FIG. 3). The temperature of the first freeze concentrator assembly 105 will then be set at −73° C., allowing the first freeze concentrator to convert liquid (e.g., water) into solids (e.g., ice crystals) and to concentrate the isopropyl alcohol in the first cooled aqueous effluent.

Once the first concentration of isopropyl alcohol in the first analysis influent stream is determined, the first operation temperature processor may determine the first operation temperature for a first freeze concentrator assembly 105 based on the determined first concentration of isopropyl alcohol as described above. According to some embodiments, depending on the first concentration of isopropyl alcohol which has been determined, the first operation temperature (e.g., freezing point) for the first freeze concentrator assembly 105 is determined based on the freezing point of a solution containing isopropyl alcohol, as illustrated in FIG. 3. According to some such embodiments, the first operation temperature processor may also be configurable or configured to communicate the first operation temperature to the first freeze concentrator. FIG. 3 illustrates example relations between the freezing point of the isopropyl alcohol (IPA) 310 (represented on the vertical or y-axis, in ° C.) and the isopropyl alcohol (IPA) concentration 320 (represented on the horizontal or x-axis, in vol. %) in an aqueous effluent. Referring to the example relationship illustrated in FIG. 3, the first operation temperature processor will be set at a much lower temperature (freezing point) as the concentration of the isopropyl alcohol (IPA) concentration increases in order to concentrate the isopropyl alcohol (IPA) that is present in the first cooled aqueous effluent. For example, the first operation (e.g., freezing point) for an aqueous effluent with a 65 vol. % of isopropyl alcohol is −29° C. (see data point 312 in FIG. 3). The temperature of the first freeze concentrator assembly 105 will then be set at −29° C., allowing the first freeze concentrator to convert liquid (e.g., water) into solids (e.g., ice crystals) and to concentrate the isopropyl alcohol in the first cooled aqueous effluent. In another example relationship, the first operation temperature (e.g., freezing point) for an aqueous effluent with a 100 vol. % of isopropyl alcohol is −73° C. (see data point 314 in FIG. 3). The temperature of the first freeze concentrator assembly 105 will then be set at −73° C., allowing the first freeze concentrator to convert liquid (e.g., water) into solids (e.g., ice crystals) and to concentrate the isopropyl alcohol in the first cooled aqueous effluent.

According to another embodiment of the invention, the temperature of the first freeze concentrator (105) may be set to a temperature below the temperature determined by the relationship between the freeing point of isopropyl alcohol and the concentration of isopropyl alcohol illustrated in FIG. 3. According to some such embodiments, setting the temperature of the first freeze concentrator (105) below the freezing point of the isopropyl alcohol solution may increase process kinetics. According to some embodiments, the temperature may be set at least 0.1° C., 0.5° C., 1° C., 2° C., 3° C., 4° C., 5° C., 10° C., or at least more than 10° C. below the freezing point of the analysis influent stream as determined by the first operation temperature processor based on the relationship illustrated in FIG. 3.

According to some embodiments, the method further includes providing the operation temperature to the first freeze concentrator assembly 105. According to some such embodiments, the first operation temperature processor is configurable or configured to communicate the first operation temperature to the first freeze concentrator.

The method includes converting the first cooled aqueous effluent received by the first freeze concentrator assembly 105 to a first solution of first ice slurry and first concentrated isopropyl alcohol. The method of converting the first cooled aqueous effluent to a first solution of first ice slurry and first concentrated isopropyl alcohol may be performed by a first freeze concentrator assembly 105, or the like. The first freeze concentrator assembly 105 may be configurable or configured to perform a variety of functions, including the reducing of the temperature of the first cooled aqueous effluent to produce a first solution of first ice slurry and first concentrated isopropyl alcohol. The first freeze concentrator assembly 105 may include a first freeze concentrator input, or the like, configurable or configured to receive the first cooled aqueous effluent from the first analysis assembly 104 and/or from the first cooling assembly 103. The first freeze concentrator assembly 105 may also include a first freeze concentrator. The first freeze concentrator may be configurable or configured to convert the first cooled aqueous effluent received by the first freeze concentrator assembly input to a first solution of first ice slurry and first concentrated isopropyl alcohol. The first freeze concentrator performs such conversion by reducing the temperature of (and/or removing heat from, etc.) the first cooled aqueous effluent. During the conversion, the first freeze concentrator may be configurable or configured to remove liquid (e.g., water) from first cooled aqueous effluent by converting them into solids (e.g., ice crystals) (e.g., by cooling and/or freezing the first cooled aqueous effluent using a coolant to circulate the first freeze concentrator). The ice crystals and water forms the ice slurry that is in the first solution of first ice slurry and first concentrated isopropyl alcohol. The first freeze concentrator assembly 105 may also include a first freeze concentrator assembly output, or the like, configurable or configured to provide the first solution of first ice slurry and first concentrated isopropyl alcohol to a first separating assembly.

The method includes separating the first ice slurry from the first concentrated isopropyl alcohol solution. The method of separating the first ice slurry may be performed by a first separating assembly 106, or the like. The first separating assembly 106 may be configurable or configured to separate the first ice slurry and the first concentrated isopropyl alcohol in the first solution of first ice slurry and first concentrated isopropyl alcohol. The first separating assembly 106 may include a first separating assembly input configurable or configured to receive the first solution of first ice slurry and first concentrated isopropyl alcohol from the first freeze concentrator assembly output. The first separating assembly 106 may further include a first separating unit, or the like, configurable or configured to separate the ice slurry from the concentrated isopropyl alcohol in the first solution of first ice slurry and first concentrated isopropyl alcohol. The first separating unit may be and/or include, but not limited to, a wash column, a centrifuge, a liquid-solid separator, a filtration system, decanter and any other suitable separating unit which may be used. Additionally or alternatively, there may be one or more first separating units in the first separating assembly 106 to perform the separation of the first ice slurry from the first concentrated isopropyl alcohol. Once the first ice slurry is separated from the first concentrated isopropyl, the first separating assembly 106 may be configurable or configured to provide, via a first separating assembly output, at least a portion or all of the obtained first ice slurry to the heat exchanger in the first cooling assembly. As described in the present disclosure, the heat exchanger may be configurable or configured to receive an ice slurry from a first separating assembly 106 as a coolant when reducing the temperature of the received filtered aqueous effluent. The first separating assembly 106 may also include a first separating assembly output, or the like, configurable or configured to provide at least a portion of the ice slurry to a first warming assembly.

The method further includes converting the first ice slurry to a liquid output. The method of converting the ice slurry may be performed by a first warming assembly 107, or the like. The first warming assembly 107 may be configurable or configured to perform a variety of functions, including the converting of first ice slurry to liquid. The first warming assembly 107 may include a first warming assembly input, or the like, configurable or configured to receive the first ice slurry from the first separating assembly output. The first warming assembly 107 may further include a first warming unit. The first warming unit may be configurable or configured to convert the first ice slurry to a liquid output. The conversion may be performed by, for example, melting, liquefy, etc. the first ice slurry into liquid (e.g., water products). The first warming unit may be and/or include, but not limited to, an ice crusher, a helical shaped heating system and any other means which may be used in the disclosure. Additionally or alternatively, the first warming assembly 107 may also be configurable or configured to receive the first ice slurry provided to the first cooling unit (e.g., heat exchanger, etc.) of the first cooling assembly 103. As described in the present disclosure, the first ice slurry is provided to the first cooling unit (e.g., first heat exchanger, etc.) of the first cooling assembly as a coolant to reduce the temperature from the filtered aqueous effluent. The process of reducing the temperature provides a warmed first ice slurry due to heat transfer. Further, the system may also include a first washing column 109, or the like. The first washing column 109 may be configurable or configured to remove surface impurities in the warmed first ice slurry from the first cooling assembly. For example, the first washing column 109 may be configurable or configured to remove impurities, including any surface impurities such as suspended solids, particles, particles, organics and dissolved solids and/or any remaining isopropyl alcohol, that is present in the warmed first ice slurry. The warmed first ice slurry may be washed several times in the first wash column to ensure the impurities and/or any remaining isopropyl alcohol is removed from the warmed first ice slurry. The first warming assembly 107 may also include a first warming assembly output, or the like, configurable or configured to provide the liquid output to a polishing assembly 108.

The method further includes removing impurities from the liquid output to arrive at a final output. The method may be performed by a first polishing assembly 108, or the like. The first polishing assembly 108 may be configured to perform a variety of functions, including the removal of remaining impurities from liquid. The first polishing assembly 108 may include a polishing assembly input, or the like, configurable or configured to receive, as input, the liquid output from the first warming assembly output. The first polishing assembly 108 may further include a first polishing unit, or the like. The first polishing unit may be configurable or configured to remove impurities from the liquid output so as to arrive at a final output. The first polishing unit may be and/or include conventional nanofiltration (NF) membranes, brackish water reverse osmosis (BWRO) membranes, sea water reverse osmosis (SWRO) membranes and/or any other suitable membranes which may be used. In an example, the first polishing unit may be configurable or configured to remove remaining impurities, including suspended solids, particles, organics and dissolved solids, to meet the reusable water quality and to produce clean or pure final output which may include water products that has no and/or significantly reduced concentration of isopropyl alcohol. The clean or pure water products are subsequently safely disposed into a water source in the environment, reused in the treatment system where applicable and/or used in any other suitable applications. The retentate (e.g., impurities, etc.) from the first polishing unit may be further processed for disposal using suitable processes or recycled, depending on application. The first polishing assembly 108 may also include a first polishing assembly output, or the like, configurable or configured to provide the final output.

In another example embodiment, the method may also further include a method for managing an aqueous effluent, particularly a concentrated isopropyl alcohol solution, with a second stage of freeze concentration process. The method includes reducing a temperature from the concentrated isopropyl alcohol solution to arrive at a first cooled concentrated isopropyl alcohol solution. The method may be performed by a second cooling assembly 110. The second cooling assembly 110 includes a second cooling assembly input that is configurable or configured to receive the first concentrated isopropyl alcohol from the first separating assembly 106. The second cooling assembly 110 further includes a second cooling unit configurable or configured to reduce a temperature in the received first concentrated isopropyl alcohol to arrive at a cooled first concentrated isopropyl alcohol. According to some embodiments, the second cooling unit is a closed loop system that is configurable or configured to reduce the temperature of the first concentrated isopropyl alcohol. The second cooling unit includes a second heat exchanger that is configurable or configured to transfer the heat or energy from the received first concentrated isopropyl alcohol into a coolant that is surrounding the first cooling unit. Examples of suitable heat exchangers for a cooling unit that may be used in the present disclosure includes, but not limited to, shell and tube heat exchanger, tube-to-fin exchanger, plate and frame heat exchangers, plate fin heat exchangers, and any other suitable heat exchangers which may be used. The second heat exchanger is configurable or configured to receive an ice slurry (e.g., second ice slurry) from a second separating assembly 113 as a coolant when reducing the temperature of the received first concentrated isopropyl alcohol. The second ice slurry from the second separating assembly 113 may be ice slurry produced from previous cycles of treating the aqueous effluent. Further, the coolant may also include, but not limited to, methanol, ethanol, a combination of methanol and ethanol, glycol, polyethylene glycols and any other suitable coolant which may be used that is provided into the system. The second cooling unit receives the first concentrated isopropyl alcohol wherein the first concentrated isopropyl alcohol flows on the outside of the tubes/plates of the heat exchanger and the coolant flows on the inside of the tubes/plates of the heat exchanger. The temperature of the first concentrated isopropyl alcohol is reduced by the transfer of heat from the first concentrated isopropyl alcohol to the coolant that is circulating the first cooling unit. The second cooling assembly 110 also includes a second cooling assembly output that is configurable or configured to provide the first cooled concentrated isopropyl alcohol to a second analysis assembly 111 and/or to a second freeze concentrator assembly.

According to some embodiments, the method may further include determining a concentration of chemical oxygen demand (COD) in a second analysis influent stream selected from the first cooled concentrated isopropyl alcohol and/or the first concentrated isopropyl alcohol from the first separating assembly. The method of determining a concentration of chemical oxygen demand (COD) may be performed by a second analysis assembly 111, or the like. The second analysis assembly 111 may include a second chemical oxygen demand (COD) analyzer configurable or configured to determine a second concentration of chemical oxygen demand (COD) in the second analysis influent stream received by the second analysis assembly input. The second chemical oxygen demand (COD) analyzer may be configurable or configured to determine a second concentration of chemical oxygen demand (COD) in the second analysis influent stream received by the second analysis assembly input. When the second analysis influent stream is received from the second cooling assembly 110, the second chemical oxygen demand (COD) analyzer may be configurable or configured to determine the second chemical oxygen demand (COD) and provide real-time information on the chemical oxygen demand (COD) concentration. Additionally or alternatively, the second analysis assembly 111 may also receive a predetermined concentration of the chemical oxygen demand (COD) in the second analysis influent stream. For example, the second concentration of the chemical oxygen demand (COD) may be one or more predetermined concentrations that are determined or obtained based on previous managements on a first cooled concentrated isopropyl alcohol. As another example, the predetermined concentrations may be a preset concentration of a second analysis influent stream from a previous management and/or retrieved from a second operation temperature processor before starting the process of managing the said first cooled concentrated isopropyl alcohol. As another example, the first concentrated isopropyl alcohol to be managed may be of an aqueous effluent collected a known or historic source. If the aqueous effluent to be managed is from a known or historic source, the second operation temperature processor (as further described in the present disclosure) may retrieve and/or receive the predetermined concentrations of the chemical oxygen demand (COD) based on previous management of the first cooled concentrated isopropyl of the aqueous effluent from the same known or historic source. Other approaches to obtaining predetermined concentrations of the chemical oxygen demand (COD) are also contemplated without departing from the teachings of the present disclosure.

According to some embodiments, the method may further include determining a concentration of total organic carbon (TOC) in the second analysis influent stream. The method of determining a concentration of total organic carbon (TOC) may be performed by a second analysis assembly 111, or the like. According to some embodiments, the second analysis assembly 111 includes a second total organic carbon (TOC) analyzer that is configurable or configured to determine a second concentration of total organic carbon (TOC) in the second analysis influent stream received by the second analysis assembly input. The second total organic carbon (TOC) analyzer may be configurable or configured to determine a second concentration of total organic carbon (TOC) in the second analysis influent stream received by the second analysis assembly input. The second total organic carbon (TOC) analyzer is configurable or configured to determine a concentration of total organic carbon (TOC) in organic compounds in the second analysis influent stream. When the second analysis assembly 111 receives the second analysis influent stream, the second total organic carbon (TOC) analyzer may be configurable or configured to determine the total organic carbon (TOC) and provide real-time information on the total organic carbon (TOC) concentration. Additionally or alternatively, the second analysis assembly 111 may also receive a predetermined concentration of the second total organic carbon (TOC) in the second analysis influent stream. For example, the concentration of the total organic carbon (TOC) may be one or more predetermined concentrations that are determined or obtained based on previous managements on the first cooled concentrated isopropyl alcohol. As another example, the predetermined concentrations may be a preset concentration of a second analysis influent stream from a previous management and/or retrieved from a second operation temperature processor (as described in the present disclosure) before starting the process of managing the said first cooled concentrated isopropyl alcohol. As another example, the first concentrated isopropyl alcohol to be managed may be of an aqueous effluent collected from a known or historic source. If the aqueous effluent to be managed is from the known or historic source, the second operation temperature processor may retrieve and/or receive the predetermined concentrations of the total organic carbon (TOC) based on previous management of the first cooled concentrated isopropyl alcohol of the aqueous effluent from the same known or historic source. Other approaches to obtaining predetermined concentrations of the total organic carbon (TOC) are also contemplated without departing from the teachings of the present disclosure.

According to some embodiments, the method may also include determining a second operation temperature for use by a second freeze concentrator assembly 112. The method of determining the second operation temperature may be performed by the second analysis assembly 112, or the like. According to some embodiments, the second analysis assembly 112 includes a second operation temperature processor, or the like. The second operation temperature processor may be configurable or configured to determine a second operation temperature for a second freeze concentrator assembly 112. The second operation temperature may be determined based on, among other things, the second concentration of chemical oxygen demand (COD) determined by the chemical oxygen demand (COD) analyzer. As such, the second operation temperature processor may be configurable or configured to receive the second concentration of the chemical oxygen demand (COD) of the second analysis influent stream from the second chemical oxygen demand (COD) analyzer. When the second operation temperature processor receives and processes the second concentration received from the second chemical oxygen demand (COD) analyzer, the second operation temperature processor may be configurable or configured to determine a second concentration of isopropyl alcohol in the second analysis influent stream based on the results (e.g., concentrations) of the chemical oxygen demand (COD) analyzer.

When the second operation temperature processor receives and processes the second concentration received from the second chemical oxygen demand (COD) analyzer, the second operation temperature processor may be configurable or configured to determine a second concentration of isopropyl alcohol in the second analysis influent stream based on the results (e.g., concentrations) of the chemical oxygen demand (COD) analyzer. FIG. 5 illustrates example relations between the chemical oxygen demand (COD) 510 (represented on the vertical or y-axis, in mg/L) and the isopropyl alcohol (IPA) concentration 520 (represented on the horizontal or x-axis, in vol. %) in a concentrated isopropyl alcohol. Referring to the example relationship illustrated in FIG. 5, when the second operation temperature processor receives a concentration of the chemical oxygen demand (COD) of 900,000 mg/L in the second analysis influent stream, the second operation temperature processor is configurable or configured to determine the concentration of the second concentration of isopropyl alcohol in the first cooled aqueous effluent to be 50 % (see data point 512 in FIG. 5) based on the relationship. Referring to another example relationship illustrated in FIG. 5, when the second operation temperature processor receives a concentration of the chemical oxygen demand (COD) of 1,600,000 mg/L in the second analysis influent stream, the second operation temperature processor is configurable or configured to determine the concentration of the second concentration of isopropyl alcohol in the second analysis influent stream to be 90 vol. % (see data point 514 in FIG. 5) based on the relationship.

The second operation temperature may also be determined based on, among other things, the second concentration of total organic carbon (TOC) determined by the total organic carbon (TOC) analyzer. As such, the second operation temperature processor may be configurable or configured to receive the second concentration of the total organic carbon (TOC) of the second analysis influent stream from the second total organic carbon (TOC) analyzer. When the second operation temperature processor receives and processes the second concentration received from the first total organic carbon (TOC) analyzer, the second operation temperature processor may be configurable or configured to determine a second concentration of isopropyl alcohol in the second analysis influent stream based on, among other things, the results (e.g., concentrations) of the total organic carbon (TOC) analyzer. A molecule of isopropyl alcohol has a molecular weight of 60.1 Da and contains 3 carbon atoms, these carbon atoms having combines molecular weight of 36.033. Therefore, isopropyl alcohol is about 60% organic carbon. Based on this relationship, the concentration of isopropyl alcohol can be estimated from the concentration of total organic carbon (TOC) determined by the TOC analyzer by dividing the result by 60%. According to some embodiments, when the second operation temperature processor receives a concentration of total organic carbon (TOC) of 100,000 mg/L in the second analysis influent stream, the second operation temperature processor may be configurable or configured to determine the concentration of the second concentration of isopropyl alcohol in the second analysis influent stream to be 160,000 mg/L, or approximately 16%, assuming a solution density of 1 kg/L. In other embodiments, the relationship between total organic carbon (TOC) and concentration of isopropyl alcohol may be estimated or extrapolated from other known relationships between total organic carbon (TOC) and isopropyl alcohol concentrations for previous or historic sources of second analysis influent stream.

Once the second concentration of isopropyl alcohol in the second analysis influent stream is determined, the second operation temperature processor may be further configurable or configured to determine the second operation temperature for a second freeze concentrator assembly 112 (i.e., a first operation temperature to be used by the second freeze concentrator assembly) based on the determined second concentration of isopropyl alcohol. Additionally or alternatively, the second operation temperature processor may also determine a second concentration of the isopropyl alcohol in the second analysis influent stream based on predetermined concentrations of the isopropyl alcohol. For example, the concentration of the isopropyl alcohol may be one or more predetermined concentrations that are determined or obtained based on previous managements on the aqueous effluent. As another example, the predetermined concentrations may be a preset concentration of isopropyl alcohol of a second analysis influent stream from a previous management and/or retrieved from the first operation temperature processor before starting the process of managing a first cooled concentrated isopropyl alcohol. As another example, the first concentrated isopropyl alcohol to be managed may be of an aqueous effluent collected from a known or historic source. If the aqueous effluent to be managed is from the known or historic source, the second operation temperature processor may retrieve and/or receive the predetermined concentrations of the chemical oxygen demand (COD) and/or total organic carbon (TOC) based on previous management of the first concentrated isopropyl from the same known or historic source. Other approaches to obtaining predetermined concentrations of the isopropyl alcohol are also contemplated without departing from the teachings of the present disclosure.

Once the second concentration of isopropyl alcohol in the second analysis influent stream is determined, the second operation temperature processor may be further configurable or configured to determine the second operation temperature for a second freeze concentrator assembly 112 based on the determined second concentration of isopropyl alcohol as described above. According to some embodiments, depending on the second concentration of isopropyl alcohol which has been determined, the second operation temperature (e.g., freezing point) for the second freeze concentrator assembly may be determined based on the freezing point of a solution containing isopropyl alcohol, as illustrated in FIG. 3. The second operation temperature processor is also configurable or configured to communicate the second operation temperature to the second freeze concentrator assembly 112. FIG. 3 illustrates example relations between the freezing point of the isopropyl alcohol (IPA) 310 (represented on the vertical or y-axis, in ° C.) and the isopropyl alcohol (IPA) concentration 320 (represented on the horizontal or x-axis, in vol. %) in a concentrated isopropyl alcohol. Referring to the example relationship illustrated in FIG. 3, the second operation temperature processor will be set at a much lower temperature (freezing point) as the concentration of the isopropyl alcohol (IPA) concentration increases in order to concentrate the isopropyl alcohol (IPA) that is present in the first cooled concentrated isopropyl alcohol. For example, the second operation (e.g., freezing point) for a concentrated isopropyl alcohol with a 65 vol. % of isopropyl alcohol is 29° C. (see data point 312 in FIG. 3). The temperature of the second freeze concentrator assembly 112 will then be set at −29° C., allowing the second freeze concentrator to convert liquid (e.g., water) into solids (e.g., ice crystals) and to concentrate the isopropyl alcohol in the first cooled concentrated isopropyl alcohol. In another example, the second operation temperature (e.g., freezing point) for a concentrated isopropyl alcohol with a 100 vol. % of isopropyl alcohol is −73° C. (see data point 314 in FIG. 3). The temperature of the second freeze concentrator assembly 112 will then be set at −73° C., allowing the second freeze concentrator to convert liquid (e.g., water) into solids (e.g., ice crystals) and to concentrate the isopropyl alcohol in the first cooled concentrated isopropyl alcohol.

According to another embodiment of the invention, the temperature of the second freeze concentrator (112) may be set to a temperature below the temperature determined by the relationship between the freeing point of isopropyl alcohol and the concentration of isopropyl alcohol illustrated in FIG. 3. According to some such embodiments, setting the temperature of the second freeze concentrator (112) below the freezing point of the isopropyl alcohol solution may increase process kinetics. According to some embodiments, the temperature may be set at least 0.1° C., 0.5° C., 1° C., 2° C., 3° C., 4° C., 5° C., 10° C., or at least more than 10° C. below the freezing point of the analysis influent stream as determined by the second operation temperature processor based on the relationship illustrated in FIG. 3.

According to some embodiments, the method further includes providing the second operation temperature determined by the second operation temperature processor and first cooled concentrated isopropyl alcohol to the second freeze concentrator assembly 112. According to some embodiments, the second operation temperature processor is configurable or configured to communicate the second operation temperature to the second freeze concentrator.

The method includes converting the first cooled concentrated isopropyl alcohol received by the second freeze concentrator assembly 112 to a second solution of ice slurry and concentrated isopropyl alcohol. The method of converting the first cooled concentrated isopropyl alcohol to a second solution of ice slurry and concentrated isopropyl alcohol may be performed by a second freeze concentrator assembly 112, or the like. The second freeze concentrator assembly 112 may be configurable or configured to perform a variety of functions, including the reducing of the temperature of the first cooled concentrated isopropyl alcohol to produce a second solution of second ice slurry and second concentrated isopropyl alcohol. The second freeze concentrator assembly 112 may include a second freeze concentrator input, or the like, configurable or configured to receive the first cooled concentrated isopropyl alcohol from the second analysis assembly 111 and/or from the second cooling assembly 110. The second freeze concentrator assembly 112 may also include a second freeze concentrator. The second freeze concentrator may be configurable or configured to convert the first cooled concentrated isopropyl alcohol received by the second freeze concentrator assembly input to a second solution of second ice slurry and second concentrated isopropyl alcohol. The second freeze concentrator may be configurable or configured to perform such conversion by reducing the temperature of (and/or removing heat from, etc.) the first cooled concentrated isopropyl alcohol. During the conversion, the second freeze concentrator is configurable or configured to remove liquid (e.g., water) from first cooled concentrated isopropyl alcohol by converting them into solids (e.g., ice crystals) (e.g., by cooling and/or freezing the first cooled concentrated isopropyl alcohol using a coolant to circulate the second freeze concentrator). The ice crystals and water forms the ice slurry that is in the second solution of second ice slurry and second concentrated isopropyl alcohol. The second freeze concentrator assembly may also include a second freeze concentrator assembly output, or the like, configurable or configured to provide the second solution of second ice slurry and second concentrated isopropyl alcohol to a second separating assembly.

The method further includes separating the second ice slurry from the second concentrated isopropyl alcohol solution. The method of separating the ice slurry may be performed by a second separating assembly 113, or the like. The second separating assembly 113 may be configurable or configured to separate the second ice slurry and the second concentrated isopropyl alcohol in the second solution of second ice slurry and second concentrated isopropyl alcohol. The second separating assembly may include a second separating assembly input configurable or configured to receive the second solution of second ice slurry and second concentrated isopropyl alcohol from the second freeze concentrator assembly output. The second separating assembly 113 may further include a second separating unit, or the like, configurable or configured to separate the ice slurry from the concentrated isopropyl alcohol in the second solution of second ice slurry and second concentrated isopropyl alcohol. The second separating unit may be and/or include, but not limited to, a wash column, a centrifuge, a liquid-solid separator, a filtration system, decanter and any other suitable separating unit which may be used. Additionally or alternatively, there may be one or more second separating units in the second separating assembly to perform the separation of the second ice slurry from the second concentrated isopropyl alcohol. Once the second ice slurry is separated from the second concentrated isopropyl, the second separating assembly 113 may be configurable or configured to provide, via a second separating assembly output, at least a portion or all of the obtained second ice slurry to the second heat exchanger in the second cooling assembly. As described in the present disclosure, the second heat exchanger may be configurable or configured to receive an ice slurry from a second separating assembly 113 as a coolant when reducing the temperature of the received first concentrated isopropyl alcohol. The second separating assembly 113 may also include a second separating assembly output, or the like, configurable or configured to provide at least a portion of the ice slurry to a second warming assembly.

The method also includes converting the second ice slurry to a second liquid output. The method of converting the second ice slurry may be performed by a second warming assembly 114, or the like. The second warming assembly 114 may be configurable or configured to perform a variety of functions, including the converting of second ice slurry to liquid. The second warming assembly 114 may include a second warming assembly input, or the like, configurable or configured to receive the second ice slurry from the second separating assembly output. The second warming assembly 114 may further include a second warming unit. The second warming unit may be configurable or configured to convert the second ice slurry to a second liquid output. The conversion may be performed by, for example, melting, liquefy, etc. the second ice slurry into liquid (e.g., water products). The second warming unit may be and/or include, but not limited to, an ice crusher, a helical shaped heating system and any other means which may be used in the disclosure. Additionally or alternatively, the second warming assembly 114 may also be configurable or configured to receive the second ice slurry provided to the second cooling unit (e.g., heat exchanger, etc.) of the second cooling assembly 110. As described in the present disclosure, the second ice slurry is provided to the second cooling unit (e.g., heat exchanger, etc.) of the second cooling assembly 110 as a coolant to reduce the temperature of the first concentrated isopropyl alcohol. The process of reducing the temperature provides a warmed second ice slurry due to heat transfer.

The method also includes removing surface impurities in the warmed second ice slurry. The method may be performed by a second washing column 116, or the like. For example, the second washing column 116 may be configurable or configured to remove impurities including any surface impurities such as suspended solids, particles, organics, dissolved solids and/or any remaining isopropyl alcohol that is present in the warmed second ice slurry. The warmed second ice slurry may be washed several times in the second washing column 116 to ensure the impurities and/or any remaining isopropyl alcohol is removed from the warmed second ice slurry. The second warming assembly 114 may also include a second warming assembly output, or the like, configurable or configured to provide the second liquid output to a second polishing assembly 115.

The method also includes removing impurities from the second liquid output to arrive at a second final output. The method may be performed by a second polishing assembly 115, or the like. The second polishing assembly 115 may be configured to perform a variety of functions, including the removal of remaining impurities from liquid. The second polishing assembly 115 may include a polishing assembly input, or the like, configurable or configured to receive, as input, the second liquid output from the second warming assembly output. The second polishing assembly 115 may further include a second polishing unit, or the like. The second polishing unit may be configurable or configured to remove impurities from the second liquid output so as to arrive at a second final output. The second polishing unit may be and/or include conventional nanofiltration (NF) membranes, brackish water reverse osmosis (BWRO) membranes, sea water reverse osmosis (SWRO) membranes and/or any other suitable membranes which may be used. In an example, the second polishing unit may be configurable or configured to remove remaining impurities, including suspended solids, particles, organics and dissolved solids, to produce clean or pure second final output which may include water products that has no and/or significantly reduced concentration of isopropyl alcohol. The clean or pure water products are subsequently safely disposed into a water source in the environment, reused in the treatment system where applicable and/or used in any other suitable applications. The retentate (e.g., impurities, etc.) from the second polishing unit may be further processed for disposal using suitable processes or recycled, depending on application. The second polishing assembly 115 may also include a second polishing assembly output, or the like, configurable or configured to provide the second final output.

U.S. Provisional Patent Application No. 63/393,127, filed Jul. 28, 2022, and entitled “Methods and Systems for Treating Aqueous Effluent,” is incorporated herein by reference in its entirety for all purposes.

While various embodiments in accordance with the disclosed principles have been described above, it should be understood that they have been presented by way of example only, and are not limiting. Thus, the breadth and scope of the example embodiments described in the present disclosure should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

Various terms used herein have special meanings within the present technical field. Whether a particular term should be construed as such a “term of art” depends on the context in which that term is used. Such terms are to be construed in light of the context in which they are used in the present disclosure and as one of ordinary skill in the art would understand those terms in the disclosed context. The above definitions are not exclusive of other meanings that might be imparted to those terms based on the disclosed context.

Additionally, the section headings and topic headings herein are provided for consistency with the suggestions under various patent regulations and practice, or otherwise to provide organizational cues. These headings shall not limit or characterize the embodiments set out in any claims that may issue from this disclosure. Specifically, a description of a technology in the “Background” is not to be construed as an admission that technology is prior art to any embodiments in this disclosure. Furthermore, any reference in this disclosure to “invention” in the singular should not be used to argue that there is only a single point of novelty in this disclosure. Multiple inventions may be set forth according to the limitations of the claims issuing from this disclosure, and such claims accordingly define the invention(s), and their equivalents, that are protected thereby. In all instances, the scope of such claims shall be considered on their own merits in light of this disclosure, but should not be constrained by the headings herein.

1. A system for managing an aqueous effluent, the system comprising:
an inlet for receiving an aqueous effluent;
a filtration assembly, the filtration assembly including:
a filtration assembly input configured to receive the aqueous effluent from the inlet;
a filter unit configured to filter impurities from the aqueous effluent, and/or a chemical treatment unit configured to remove impurities to arrive at a filtered aqueous effluent; and
a filtration assembly output configured to provide the filtered aqueous effluent to a first cooling assembly;
the first cooling assembly, the first cooling assembly including:
a first cooling assembly input configured to receive the filtered aqueous effluent from the filtration assembly;
a first cooling unit configured to reduce a temperature of the received filtered aqueous effluent to arrive at a first cooled aqueous effluent; and
a first cooling assembly output configured to provide the first cooled aqueous effluent to a first analysis assembly;
the first analysis assembly, the first analysis assembly including:
a first analysis assembly input configured to receive a first analysis influent stream selected from the aqueous effluent, the filtered aqueous effluent, and/or the first cooled aqueous effluent;
a first chemical oxygen demand (COD) analyzer configured to determine a concentration of chemical oxygen demand (COD) in the first analysis influent stream received by the analysis assembly input, and/or a first total organic carbon (TOC) analyzer configured to determine a concentration of total organic carbon (TOC) in the first cooled aqueous effluent received by the first analysis assembly input;
a first operation temperature processor configured to determine an operation temperature for a first freeze concentrator assembly, the operation temperature determined based on the concentration of chemical oxygen demand (COD) determined by the COD analyzer and/or the concentration of total organic carbon (TOC) determined by the TOC analyzer; and
a first analysis assembly output configured to provide the operation temperature determined by the operation temperature processor;
the first freeze concentrator assembly, the first freeze concentrator assembly including:
a first freeze concentrator assembly input configured to receive the first cooled aqueous effluent;
a first freeze concentrator configured to convert the first cooled aqueous effluent received by the first freeze concentrator assembly input to a first solution of first ice slurry and first concentrated isopropyl alcohol; and
a first freeze concentrator assembly output configured to provide the first solution of first ice slurry and first concentrated isopropyl alcohol to a first separating assembly;
the first separating assembly, the first separating assembly including:
a first separating assembly input configured to receive the first solution of first ice slurry and first concentrated isopropyl alcohol from the first freeze concentrator assembly output;
a first separating unit configured to separate the first ice slurry from the first concentrated isopropyl alcohol; and
a first separating assembly output configured to provide at least a portion of the first ice slurry to a first warming assembly;
the first warming assembly, the first warming assembly including:
a first warming assembly input configured to receive the first ice slurry from the first separating assembly output;
a first warming unit configured to convert the first ice slurry to a first liquid output; and
a first warming assembly output configured to provide the first liquid output to a first polishing assembly; and
the first polishing assembly, the first polishing assembly including:
a first polishing assembly input configured to receive the first liquid output from the first warming assembly output;
a first polishing unit configured to remove impurities from the first liquid output to arrive at a first final output; and
a first polishing assembly output configured to provide the first final output.

2. The system of claim 1, wherein the filter unit includes at least one of the following:
an ultrafiltration system;
a reverse osmosis system;
a cartridge filtration system; and/or
a membrane cartridge filtration system.

3. The system of claim 1,
wherein the first cooling unit includes a first heat exchanger;
wherein the first separating assembly output is configured to provide at least a portion of the first ice slurry to the first heat exchanger; and
wherein the heat exchanger is configured to perform the reduction of temperature from the received filtered aqueous effluent to arrive at the first cooled aqueous effluent using the first ice slurry received from the first separating assembly output.

4. The system of claim 1, wherein the operation temperature processor is further configured to:
determine a first concentration of isopropyl alcohol in the first analysis influent stream based on results of the first COD analyzer and/or the first TOC analyzer;
wherein the operation temperature determined by the first operation temperature processor is further based on the first concentration of isopropyl alcohol.

5. (canceled)

6. The system of claim 1, wherein the first polishing unit includes at least one of the following:
nanofiltration (NF) membranes;
brackish water reverse osmosis (BWRO) membranes; and/or
sea water reverse osmosis (SWRO) membranes.

7. The system of claim 1, further comprising a second cooling assembly, the second cooling assembly including:
a second cooling assembly input configured to receive the first concentrated isopropyl alcohol from the first separating assembly;
a second cooling unit configured to reduce a temperature from the received first concentrated isopropyl alcohol to arrive at a first cooled concentrated isopropyl alcohol; and
a second cooling assembly output configured to provide the first cooled concentrated isopropyl alcohol.

8. The system of claim 7,
wherein the second cooling unit includes a second heat exchanger;
wherein the second heat exchanger is configured to receive a second ice slurry; and
wherein the second heat exchanger is configured to perform the reduction of temperature from the received first concentrated isopropyl alcohol to arrive at the first cooled concentrated isopropyl alcohol using the second ice slurry.

9. The system of claim 8, further comprising a second analysis assembly, the second analysis assembly including:
a second analysis assembly input configured to receive a second analysis influent stream selected from the first concentrated isopropyl alcohol and/or the first cooled concentrated isopropyl alcohol;
a second chemical oxygen demand (COD) analyzer configured to determine a concentration of chemical oxygen demand (COD) in the second analysis influent stream received by the second analysis assembly input and/or a second total organic carbon (TOC) analyzer configured to determine a concentration of total organic carbon (TOC) in the first cooled concentrated isopropyl alcohol received by the second analysis assembly input;
a second operation temperature processor configured to determine a second operation temperature for a second freeze concentrator assembly, the second operation temperature determined based on the concentration of chemical oxygen demand (COD) determined by the second COD analyzer and/or the concentration of total organic carbon (TOC) determined by the second TOC analyzer; and
a second analysis assembly output configured to provide the second operation temperature determined by the second operation temperature processor to the second freeze concentrator assembly.

10. The system of claim 9, wherein the second operation temperature processor is configured to:
determine a second concentration of isopropyl alcohol in the second analysis influent stream based on results of the second chemical oxygen demand (COD) analyzer and/or the second total organic carbon (TOC) analyzer;
wherein the second operation temperature determined by the second operation temperature processor is further based on the second concentration of isopropyl alcohol.

11. The system of claim 9, further comprising the second freeze concentrator assembly, the second freeze concentrator assembly including:
a second freeze concentrator assembly input configured to receive the first cooled concentrated isopropyl alcohol;
a second freeze concentrator configured to convert the first cooled concentrated isopropyl alcohol received by the second freeze concentrator assembly input to a second solution of a second ice slurry and a second concentrated isopropyl alcohol; and
a second freeze concentrator assembly output configured to provide the second solution of the second ice slurry and the second concentrated isopropyl alcohol to a second separating assembly.

12. The system of claim 11, further comprising the second separating assembly, the second separating assembly including:
a second separating assembly input configured to receive the second solution of the second ice slurry and the second concentrated isopropyl alcohol from the second freeze concentrator assembly output;
a second separating unit configured to separate the second ice slurry from the second concentrated isopropyl alcohol; and
a second separating assembly output configured to provide at least a portion of the second ice slurry to a second warming assembly.

13. The system of claim 12, further comprising the second warming assembly, the second warming assembly including:
a second warming assembly input configured to receive the second ice slurry from the second separating assembly output;
a second warming unit configured to convert the second ice slurry to a second liquid output; and
a second warming assembly output configured to provide the second liquid output to a second polishing assembly.

14. The system of claim 13, further comprising the second polishing assembly, the second polishing assembly including:
a second polishing assembly input configured to receive the second liquid output from the second warming assembly output;
a second polishing unit configured to remove impurities from the second liquid output to arrive at a second final output; and
a second polishing assembly output configured to provide the second final output.

15. (canceled)

16. A method for managing an aqueous effluent, the method comprising:
receiving an aqueous effluent;
filtering impurities and/or chemical treatment for the removal of impurities from the aqueous effluent to arrive at a filtered aqueous effluent;
reducing a temperature of the received filtered aqueous effluent to arrive at a first cooled aqueous effluent;
determining a concentration of chemical oxygen demand (COD) in a first analysis influent stream selected from the aqueous effluent, the filtered aqueous effluent, and/or the first cooled aqueous effluent, and/or determining a concentration of total organic carbon (TOC) in the first analysis influent stream;
determining an operation temperature for use by a first freeze concentrator assembly, the operation temperature determined based on the concentration of chemical oxygen demand (COD) and/or the concentration of total organic carbon (TOC);
providing the operation temperature and the first cooled aqueous effluent to the first freeze concentrator assembly;
converting the first cooled aqueous effluent received by the first freeze concentrator assembly to a first solution of first ice slurry and first concentrated isopropyl alcohol;
separating the first ice slurry from the first concentrated isopropyl alcohol;
converting the first ice slurry to a first liquid output; and
removing impurities from the first liquid output to arrive at a first final output.

17. The method of claim 16, wherein the filtering of impurities from the aqueous effluent is performed using at least one of the following:
an ultrafiltration system;
a reverse osmosis system;
a cartridge filtration system; and
a membrane cartridge filtration.

18. The method of claim 16, further comprising:
determining a first concentration of isopropyl alcohol in the first cooled aqueous effluent based on the concentration of chemical oxygen demand (COD) in the first analysis influent stream and/or the concentration of total organic carbon (TOC) in the first analysis influent stream;
wherein the operation temperature is further based on the first concentration of isopropyl alcohol.

19. (canceled)

20. The method of claim 16, wherein the removing of the impurities from the first liquid output is performed via at least one of the following:
nanofiltration (NF) membranes;
brackish water reverse osmosis (BWRO) membranes; and/or
sea water reverse osmosis (SWRO) membranes.

21. The method of claim 16, further comprising reducing a temperature of the concentrated isopropyl alcohol solution to arrive at a first cooled concentrated isopropyl alcohol.

22. The method of claim 21, further comprising providing at least a portion of a second ice slurry to a second heat exchanger;
wherein the reduction of temperature of the concentrated isopropyl alcohol solution to arrive at the first cooled concentrated isopropyl alcohol is performed using a second ice slurry.

23. The method of claim 22, further comprising:
determining a concentration of chemical oxygen demand (COD) in a second analysis influent stream, selected from the first concentrated isopropyl alcohol and/or the first cooled concentrated isopropyl alcohol and/or determining a concentration of total organic carbon (TOC) in the second analysis influent stream;
determining a second operation temperature for a second freeze concentrator assembly, the second operation temperature determined based on the concentration of chemical oxygen demand (COD) and/or the concentration of total organic carbon (TOC); and
providing the second operation temperature and the first cooled concentrated isopropyl alcohol to the second freeze concentrator assembly.

24. The method of claim 23, further comprising:
determining a second concentration of isopropyl alcohol in the second analysis influent stream based on the concentration of chemical oxygen demand (COD) in the second analysis influent stream and/or the concentration of total organic carbon (TOC) in the second analysis influent stream;
wherein the second operation temperature is further based on the second concentration of isopropyl alcohol.

25. The method of claim 24, further comprising converting the first cooled concentrated isopropyl alcohol received by the second freeze concentrator assembly to a second solution of a second ice slurry and a second concentrated isopropyl alcohol.

26. The method of claim 25, further comprising:
receiving the second solution of the second ice slurry and the second concentrated isopropyl alcohol from the second freeze concentrator assembly; and
separating the second ice slurry from the second concentrated isopropyl alcohol.

27. The method of claim 26, further comprising converting the second ice slurry to a second liquid output.

28. The method of claim 27, further comprising removing impurities from the second liquid output to arrive at a second final output.

29. The method of claim 28, wherein the removing of the impurities from the second liquid output is performed via at least one of the following:
nanofiltration (NF) membranes;
brackish water reverse osmosis (BWRO) membranes; and/or
sea water reverse osmosis (SWRO) membranes.

30. A system for managing an aqueous effluent, the system comprising:
a filtration assembly, the filtration assembly including:
a filtration assembly input configured to receive an aqueous effluent;
a filter unit configured to filter impurities from the aqueous effluent, and/or a chemical treatment unit configured to remove impurities to arrive at a filtered aqueous effluent; and
a filtration assembly output configured to provide the filtered aqueous effluent to a first cooling assembly;
the first cooling assembly, the first cooling assembly including:
a first cooling assembly input configured to receive the filtered aqueous effluent from the filtration assembly;
a first cooling unit configured to reduce a temperature of the received filtered aqueous effluent to arrive at a first cooled aqueous effluent; and
a first cooling assembly output configured to provide the first cooled aqueous effluent to a first analysis assembly and/or to a first freeze concentrator assembly;
the first analysis assembly, the first analysis assembly including:
a first analysis assembly input configured to receive a first analysis influent stream selected from the aqueous effluent, the filtered aqueous effluent, and/or the first cooled aqueous effluent;
a first analyzer configured to determine at least one of the following: a concentration of chemical oxygen demand (COD) in the first analysis influent stream; a concentration of total organic carbon (TOC) in the first analysis influent stream; and a concentration of isopropyl alcohol in the first analysis influent stream;
a first operation temperature processor configured to determine an operation temperature for a first freeze concentrator assembly, the operation temperature determined based on the results of the first analyzer; and
a first analysis assembly output configured to provide the operation temperature determined by the operation temperature processor to the first freeze concentrator assembly;
the first freeze concentrator assembly, the first freeze concentrator assembly including:
a first freeze concentrator assembly input configured to receive the first cooled aqueous effluent from the first analysis assembly output;
a first freeze concentrator configured to convert the first cooled aqueous effluent received by the first freeze concentrator assembly input to a first solution of first ice slurry and first concentrated isopropyl alcohol; and
a first freeze concentrator assembly output configured to provide the first solution of first ice slurry and first concentrated isopropyl alcohol to a first separating assembly;
the first separating assembly, the first separating assembly including:
a first separating assembly input configured to receive the first solution of first ice slurry and first concentrated isopropyl alcohol from the first freeze concentrator assembly output;
a first separating unit configured to separate the first ice slurry from the first concentrated isopropyl alcohol; and
a first separating assembly output configured to provide at least a portion of the first ice slurry to a first warming assembly; and
the first warming assembly, the first warming assembly including:
a first warming assembly input configured to receive the first ice slurry from the first separating assembly output;
a warming unit configured to convert the ice slurry to a liquid output; and
a first warming assembly output configured to provide the liquid output.

31-39. (canceled)
